(19) United States
(12) Patent Application Publication
(10) Pub. No.: US 2019/0367369 A1
(43) Pub. Date: Dec. 5, 2019

(54) CARBON NANOTUBE MATERIAL, METHOD FOR PRODUCTION AND TREATMENT OF THE SAME

(71) Applicant: CAMBRIDGE ENTERPRISE LIMITED, Cambridge, Cambridgeshire (GB)

(72) Inventors: John BULMER, Cambridge (GB); Francisco OROZCO, Cambridge (GB); Thurid GSPANN, Cambridge (GB); Martin SPARKES, Cambridge (GB); William O'NEILL, Cambridge (GB); James ELLIOTT, Cambridge (GB); Krzysztof KOZIOL, Cranfield, Bedfordshire (GB)

(73) Assignee: CAMBRIDGE ENTERPRISE LIMITED, Cambridge, Cambridgeshire (GB)

(21) Appl. No.: 16/478,978

(22) PCT Filed: Jan. 17, 2018
(86) PCT No.: PCT/EP2018/051100

§ 371 Date: Jul. 18, 2019

(30) Foreign Application Priority Data
Jan. 19, 2017 (GB) 1700930.9

(51) Int. Cl. C01B 32/172; C01B 32/16

(52) U.S. Cl. CPC C01B 32/172; C01B 32/16; C01B 2202/02; C01B 2202/04; C01B 2202/22; B82Y 30/00; C01P 2004/03; C01P 2002/82; C01P 2002/88; C01P 2002/72; C01B 2202/34

(57) ABSTRACT

In a method for treating carbon nanotube-based material, the carbon nanotube-based material is suspended in an oxidative atmosphere. An illumination portion is illuminated with electromagnetic radiation to heat the illumination portion, the illumination portion being out of direct contact with any supporting surface. Heat is continuously conducted away from the illumination portion to a non-illumination portion of the carbon nanotube-based material. This heating in the oxidative atmosphere causes at least partial oxidation and at least partial removal of amorphous carbon, partly ordered non-tubular carbon, and/or defective nanotubes in the carbon nanotube-based material, leaving a treated material comprising an arrangement of remaining carbon nanotubes.

This material is based on work supported by the Air Force Office of Scientific Research under award number FA9550-14-1-0070 P0002.

### BACKGROUND TO THE INVENTION

### Field of the Invention

The present invention relates to a carbon nanotube-based material, a method for the production of a carbon nanotube-based material and a method for the treatment of a carbon nanotube-based material.

### Related Art

Processes are known for the production of high quality carbon nanotube-based materials. For example, US 2013/0228830 builds on a process for the production of an aerogel of carbon nanotubes and associated impurities via a floating catalyst CVD method, the aerogel then being consolidated into a fibre or a film. US 2013/0228830 discloses further densification of the fibre by applying an aerosol of acetone to the fibre, the acetone subsequently being removed by evaporation and thereby causing further densification of the fibre. Additionally, US 2013/0228830 proposes treatment of the fibre by laser illumination. An infrared (wavelength 15000 nm) 600 W CO2 pulsed laser was used to illuminate the entire fibre sample for 10, 20, 30, 50, 100 or 300 ms. This has the effect of ablation of impurities in the fibre by melting, vaporizing or exploding them. From this explanation can be understood that the laser illumination is conducted in vacuum or inert atmosphere. The effect of illumination for 30 ms is explained in US 2013/0228830 as being an improvement in densification and alignment of the carbon nanotubes.

U.S. Pat. No. 7,973,295 discloses a process of making a CNT film, irradiating the CNT film with a laser with a power density of greater than 0.1×10⁴ W/m², thereby converting the CNT film to a transparent CNT film. In this process, the CNT film is made by forming a super-aligned CNT array on a substrate and removing these by pulling with adhesive tape. The CNT film is therefore supported on a substrate during the irradiation process, which is carried out in an oxidative atmosphere. U.S. Pat. No. 8,889,217 provides a similar disclosure.

U.S. Pat. No. 7,659,139 discloses a process of irradiating a mixture of semiconducting and metallic CNTs formed as a film on a substrate using a laser in order selectively to destroy semiconducting or metallic CNTs by virtue of resonant absorption of the laser energy.

U.S. Pat. No. 7,880,376 discloses the formation of mats of CNTs by electrophoresis, for example, onto a substrate. The CNT mats are then subjected to laser treatment in order to promote their utility in field emission devices. U.S. Pat. No. 7,341,498 provides a similar disclosure.

In the academic literature, various work is reported relating to the effect of laser irradiation of carbon nanotubes. Some of this literature is discussed below.

Ajayan et al. (2002) disclose the effect of a conventional photographic flash on single wall carbon nanotubes (SWCNTs). Their testing was carried out on a sample containing SWCNTs, multiwall carbon nanotubes (MWCNTs), graphite powder, fluffy soot, 060 and metal catalyst particles. Their work showed that SWCNTs ignite and oxidize, leaving the multiwall carbon nanotubes (MWCNTs), graphite powder, fluffy soot, C60 and oxidized metal catalyst particles. Braidy et al. (2002) provides similar disclosure.

Yudasaka et al. (2003) disclose a process for light-assisted oxidation of SWCNTs. SWCNTs were treated with H₂O₂ and irradiated with light. The SWCNTs were formed using the HiPco (high pressure carbon monoxide) process and were purified by 02 treatment and HCl treatment to remove Fe particles. The CNTs were mixed with an aqueous solution of H₂O₂ and were subjected to laser irradiation during this time. The temperature of the mixture was up to 70° C. This work appears to show that the oxidation of SWCNTs was enhanced due to the laser irradiation, and furthermore that this process was diameter-selective.

Kichambare et al. (2001) disclose the laser irradiation of CNTs in air using laser pulses with different energy fluences. The CNTs were grown by microwave CVD as films on Fe-coated Si substrates. CNTs were transformed into sub-micron sized plates and cauliflower type aggregation of carbon deposits. Raman analysis suggests that a peak at 2700 cm⁻¹ in the pure CNTs, attributed to disorder induced by nanotube curvature, is reduced by the laser irradiation treatment.

Corio et al. (2002) disclose work on the evolution of the molecular structure of metallic and semiconducting carbon nanotubes under laser irradiation. The CNTs were produced by the electric arc discharge method. The effect of the laser treatment was to burn off the smaller diameter CNTs, leading to an increase in the mean diameter of the CNTs. FIG. 4 of Corio et al. (2012) shows resonant Raman spectra of SWCNTs before and after laser treatment in air.

Huang et al. (2006) disclose the preferential destruction of metallic single-walled carbon nanotubes by laser irradiation in air, whereas the semiconducting single-walled carbon nanotubes could be retained. FIGS. 2 and 4 of Huang et al. (2006) shows an example of how a laser process in air after many minutes preferentially removes metallic single wall CNTs. This is shown with the modification of the radial breathing modes. Mahjouri-Samani et al. (2009) also disclose the laser induced selective removal of metallic carbon nanotubes.

Souza et al. (2015) investigated defect healing and purification of single-wall carbon nanotubes with laser radiation by time-resolved Raman spectroscopy. The SWCNTs were formed by pulsed laser deposition into freestanding mats.

Marković et al. (2012) studied the effect of laser irradiation on thin films of SWCNTs in air, with different types of SWCNTs (from different sources) responding differently to the laser irradiation treatment. CNTs supported on a substrate experienced a crystallinity enhancement and decrease in amorphous carbon after laser treatment in air.

Mialichi et al. (2013) disclose the effect of laser irradiation of carbon nanotube films in vacuum and in air. Films of MWCNTs irradiated in air showed an enhancement in thermal conductance but an increase in defects.

Wei et al. (1997) showed that laser irradiation can result in the transformation of CNTs to diamond. Ramadurai at al. (2009) disclosed that MWCNTs exposed to high laser power densities could transform into structurally different forms of carbon, although SWCNTs did not show the same effect.

Liu et al. (2012) disclose a process in which CNTs yarns are fabricated and treated by a laser sweep in vacuum in order to recover defects. The authors also speculate that the laser sweep acts to weld carbon nanotube joints.

### SUMMARY OF THE INVENTION

It is of particular interest in the present disclosure to consider how the practical performance of carbon nanotube based materials can be improved. As an example of a material type, CNT-based textiles have emerging applications in field emission, flexible touch screens and electrical wire. In each of these exemplary applications, electrical conductivity is important. To date, the highest reported electrical conductivity of such CNT cables is 6 MS/m [Behabtu et al. (2013)]. For an individual CNT however, the typical measured electrical conductivity is about 280 MS/m. This is about five times the electrical conductivity of copper, at about 60 MS/m. It is therefore apparent that there is still room for improvement in the electrical conductivity of CNT cables and, more generally, for CNT-based materials which are capable of being self-supporting. Such materials are sometimes referred to as “self supporting CNT materials”. They are self supporting in the sense that a piece of the material can be suspended, e.g. from two opposing ends of the piece of material, and the piece of material can support at least its own weight without breakage of the piece of material. It is also of interest in the present disclosure to promote thermal conductivity of the CNT-based materials.

The present inventors consider that increasing the internal CNT alignment, enhancing the graphitic crystallinity, preserving single wall CNTs and/or preserving double wall CNTs, and/or removing impurities are of importance for improving the conductivity of self-supporting CNT-based materials.

For practical self-supporting CNT-based materials, there is a spectrum of CNT quality, length, and chirality. In turn, this leads to a large envelope of bulk material properties. Research at Rice University has led to a multistep wet chemistry process that aligns CNTs to achieve a high conductivity fiber. However, this process limits the length of these CNTs individually to less than 20 μm. An alternative, floating catalyst CVD production process developed at the University of Cambridge creates CNT textiles in which the individual CNTs have lengths of the order of 100 μm and longer.

It is considered that one disadvantage with the University of Cambridge process over the Rice University process however is a greater degree of residual catalyst, amorphous carbon and/or partly ordered non-tubular carbon in the material following the University of Cambridge process, as well as more defective CNTs. However, the University of Cambridge process provides a fundamental advantage in terms of the length of the CNTs. It is therefore of significant interest to capitalize on this length advantage, to seek to improve alignment, crystallinity, and/or purity of the self-supporting CNT-based material.

The present invention has been devised in order to address at least one of the above problems. Preferably, the present invention reduces, ameliorates, avoids or overcomes at least one of the above problems.

Accordingly, in a first preferred aspect, the present invention provides a method for treating carbon nanotube-based material including the steps:

providing a carbon nanotube-based material;
suspending the carbon nanotube-based material in an oxidative atmosphere;
illuminating an illumination portion of the carbon nanotube-based material with electromagnetic radiation to heat the illumination portion, the illumination portion being out of direct contact with any supporting surface, heat being continuously conducted away from the illumination portion to a non-illumination portion of the carbon nanotube-based material, said heating in the oxidative atmosphere causing at least partial oxidation and at least partial removal of amorphous carbon, partly ordered non-tubular carbon and/or defective nanotubes in the carbon nanotube-based material, leaving a treated material comprising an arrangement of remaining carbon nanotubes.

In a second preferred aspect, the present invention provides a method for manufacturing and treating a carbon nanotube-based material including the steps:

forming an aerogel comprising at least carbon nanotubes, amorphous carbon, partly ordered non-tubular carbon and catalyst particles by nucleation and growth of carbon nanotubes from a carbon material feedstock and floating catalyst particles in a reactor;
extracting and consolidating the aerogel into a carbon nanotube-based material;
suspending the carbon nanotube-based material in an oxidative atmosphere;
illuminating an illumination portion of the carbon nanotube-based material with electromagnetic radiation to heat the illumination portion, the illumination portion being out of direct contact with any supporting surface, heat being continuously conducted away from the illumination portion to a non-illumination portion of the carbon nanotube-based material, said heating in the oxidative atmosphere causing at least partial oxidation and at least partial removal of amorphous carbon, partly ordered non-tubular carbon and/or defective nanotubes in the carbon nanotube-based material, leaving a treated material comprising an arrangement of remaining carbon nanotubes.

In a third preferred aspect, the present invention provides a carbon nanotube-based material comprising carbon nanotubes of average length at least 100 μm, the carbon nanotubes of the material being aligned to the extent that: the material has a Herman orientation parameter of at least 0.5 for morphologies in which micro-structure misalignment relative to the intended axis of micro-structure alignment is not constrained to one direction over another; and a Chebyshev's polynomial factor of at least 0.5 for morphologies in which micro-structure misalignment relative to the intended axis of micro-structure alignment is predominantly constrained to one plane

In a fourth preferred aspect, the present invention provides a carbon nanotube-based material comprising carbon nanotubes of average length at least 100 μm, the carbon nanotubes of the material having graphitic crystallinity to the extent that when the material is subjected to non-polarized Raman spectroscopy to measure the ratio D:G of the magnitude of the D peak to the magnitude of the G peak, with magnitudes calculated by performing a baseline subtraction and integrating under the peaks, with Raman laser intensity sufficiently low to keep the calculated D:G ratio independent of Raman laser intensity within 10%, using light of wavelength 523 nm and 785 nm, the D:G ratio is at most 0.025 for 523 nm light and at most 0.1 for 785 nm light.

In a fifth preferred aspect, the present invention provides a carbon nanotube-based material comprising carbon nanotubes of average length at least 100 μm, the carbon nanotubes of the material having graphitic crystallinity to the extent that when the material is subjected to non-polarized Raman spectroscopy to measure the ratio D:G of the magnitude of the D peak to the magnitude of the G peak, with magnitudes calculated by performing a baseline subtraction and integrating under the peaks, with Raman laser intensity sufficiently low to keep the calculated D:G ratio independent of Raman laser intensity within 10%, using light of different wavelengths, when the D:G ratio is plotted against the fourth power of the wavelength and fitted to a straight line, with the straight line numerically constrained to the origin, the adjusted R² is at least 0.7.

The first, second, third, fourth and/or fifth aspect of the invention may have any one or, to the extent that they are compatible, any combination of the following optional features.

It is considered at the time of writing, without wishing to be bound by theory, that heating in the oxidative atmosphere causes at least partial oxidation and at least partial removal of nanotubes not part of a sufficient thermally conductive pathway in the material. Those nanotubes, being unable to transport heat away suitably quickly, are consequently heated to a degree that permits their oxidation. Preferably, the carbon nanotube-based material has a footprint area of at least 0.1 cm². Here it is intended that the “footprint” area is the plan view area or silhouette area of the material. Although the invention can be carried out on relatively small samples of material such as a footprint area of at least 0.1 cm², in some embodiments the invention is carried out on substantially larger material samples, for example having a footprint area of at least 1 cm², more preferably a footprint area of at least 5 cm², more preferably a footprint area of at least 10 cm², more preferably a footprint area of at least 50 cm². In some embodiments, the method of the invention may be carried out substantially continuously. As will be understood, the illuminated portion typically takes up only a minor proportion of the entire footprint area of the carbon nanotube-based material at any one time.

Preferably, the carbon nanotube-based material comprises at least 50 wt % carbon nanotubes. This may be assessed by thermogravimetric analysis (TGA). Furthermore, preferably the carbon nanotube-based material comprises at least 5 wt % carbon nanotubes selected from one or more of: single wall carbon nanotubes, double wall carbon nanotubes, and triple walled carbon nanotubes. Again, this may be assessed by TGA.

Preferably, single, double and triple wall carbon nanotubes in the carbon nanotube-based material have an average length of at least 100 μm. This is a substantial average length (measured as explained below). Suitable carbon nanotube materials may be made via a floating catalyst chemical vapour deposition (CVD) method.

The density of the carbon nanotube-based material may be at least 0.05 gcm⁻³. More preferably, the density of the carbon nanotube-based material may be at least 0.1 gcm⁻³. In some embodiments, the density of the carbon nanotube-based material may be up to about 1 gcm⁻³. More preferably, the density of the carbon nanotube-based material may be up to 0.8 gcm⁻³ or up to 0.7 gcm⁻³ or up to 0.64 gcm⁻³.

Preferably, the non-illumination portion of the carbon nanotube-based material has an area of at least 5 times the area of the illumination portion at a given instant in time during treatment. This is intended to ensure that there is sufficient non-illuminated material at any one time which is available as a heat sink from the illumination portion for those CNTs in the illumination portion forming part of a sufficiently thermally conductive pathway.

Preferably, the electromagnetic radiation is moved relative to the carbon nanotube-based material so as to move the illumination portion progressively along the carbon nanotube-based material. Preferably, such progressive movement is a substantially continuous movement, without stopping (except optionally at the limits of movement of the illumination portion with respect to the material). It has been found that such a scanning type approach can provide the treated material with satisfactory uniform properties, compared with a stop-start approach. Preferably, the carbon nanotube-based material (the ‘as-is’ material) has a direction of preferential alignment of the carbon nanotubes. The direction of relative movement of the illumination portion is preferably substantially parallel to the direction of preferential alignment of the carbon nanotubes.

Preferably, the illumination of the illumination portion by the electromagnetic radiation takes place over a relatively short time scale. As explained elsewhere in this disclosure, it is considered that the illumination portion undergoes an oxidation chemical reaction. Preferably, the illumination takes place over a time scale not longer than the duration of the oxidation chemical reaction itself. More preferably, this time scale is shorter (more preferably substantially shorter) than the duration of the oxidation chemical reaction.

Preferably, the electromagnetic radiation is pulsed. This is a convenient way to ensure that the duration of the illumination, corresponding to the pulse length, is of the time scale explained above.

Still further, for a region of the material being illuminated, preferably, the total time of illumination by the electromagnetic radiation (corresponding to the sum of the duration of pulses received by the region illumination during a single pass) is not longer than the oxidation chemical reaction itself. The duration of the oxidation chemical reaction may be assessed based on the duration of the white oxidative flash. More preferably, the total time of illumination by the electromagnetic radiation is substantially shorter than the oxidation chemical reaction.

Taking the steps above is found to provide advantages in the sense that the material being treated is then less likely to be burned away completely.

The temperature of the illumination portion may be at least 300° C. This temperature may be achieved as a result of the absorption of the electromagnetic radiation by the carbon nanotube-based material, and any external additional sources of heat, such as a hot plate or furnace. Additional contribution to the temperature of the illumination portion is also provided by resultant oxidation reactions taking place at the illumination portion. The illumination portion may be heated to a temperature of at most 2500° C. In some embodiments, the illumination portion may be heated to a temperature of at most 1600° C. A pyrometer can be used to measure the temperature of the area of interest. The pyrometer should be aimed immediately adjacent to the oxidation flash in space or immediately after the oxidation event in time. This measurement approach yields a lower bound value in the temperature of the area of interest. If the light from the oxidation chemical reaction itself, beyond black body radiation, is measured by the pyrometer then this reading yields an upper bound value for temperature of the area of interest. Note that the temperature can be measured with Raman spectroscopy by considering the Stokes and anti Stokes modes of the G peak according to [Tristant et al, Nanoscale (2016)].

Preferably, the fluence and/or intensity of the electromagnetic radiation at the illumination portion is sufficient to heat the carbon nanotube-based material to reach at least the lowest ignition temperature of all present carbon species at the illumination portion.

Preferably, the oxidative environment is simply air from the ambient atmosphere, but could be any gas causing an oxidation reaction with the carbon species in the material. It is also possible oxidizing agents could be added to the CNT material to supply and/or assist in the oxidation reaction, such as hydrogen peroxide. These other additional sources of oxidation are also included in the scope of the patent.

The ratio of the mass of the illumination portion after the process to the mass of the illumination portion before the process may be at most 0.9. The ratio of the mass of the illumination portion after the process to the mass of the illumination portion before the process may be at least 0.01. In this way, it is clear that the treatment applied to the material results in some mass loss, which is attributed to oxidation of carbon.

The treated material may be further treated to remove at least some residual catalyst particles, as well as any remaining amorphous carbon from the primary process. This may be carried out by acid treatment, preferably non-oxidative acid treatment, in a known manner.

In the treated material, preferably the carbon nanotubes are aligned to the extent that the material has a Herman orientation parameter of at least 0.5 for morphologies such that micro-structure misalignment relative to the intended axis of micro-structure alignment is not constrained to one direction over another. More preferably, the Herman orientation parameter is at least 0.6 or at least 0.7 for these said morphologies. For morphologies such that micro-structure misalignment relative to the intended axis of micro-structure alignment is predominantly constrained to one plane, preferably the Chebyshev's polynomial factor is at least 0.5. More preferably for these morphologies, the Chebyshev's polynomial factor is at least 0.6 or at least 0.7.

In the treated material, preferably the carbon nanotubes have a graphitic crystallinity to the extent that when the material is subjected to non-polarized Raman spectroscopy to measure the ratio D:G of the magnitude of the D peak to the magnitude of the G peak, with magnitudes calculated by performing a baseline subtraction and integrating under the peaks, with Raman laser intensity sufficiently low to keep the calculated D:G ratio independent of Raman laser intensity within 10%, using light of wavelength 523 nm and 785 nm, the D:G ratio is at most 0.025 for 523 nm light and at most 0.1 for 785 nm light.

In the treated material, preferably the carbon nanotubes have a graphitic crystallinity to the extent that when the material is subjected to non-polarized Raman spectroscopy to measure the ratio D:G of the magnitude of the D peak to the magnitude of the G peak, using light of different wavelengths, when the D:G ratio is plotted against the fourth power of the Raman laser excitation wavelength and fitted to a straight line, with the straight line numerically constrained to the origin, the adjusted R² is at least 0.7. More preferably, the reduced R² is at least 0.8.

In some embodiments, the material is in the form of a fibre, textile, sheet or film. Preferably, the material is provided in a free-standing format, without the need for a substrate for support. The material may be light-transmissive. For example, the material may be substantially transparent, or fully transparent.

The inventors have additionally noted that, in some embodiments, applying the method of the invention to the carbon nanotube-based material does not change the radial breathing modes of the CNTs in the Raman spectrum after treatment according to the preferred methods of the invention.

Further optional features of the invention are set out below.

### BRIEF DESCRIPTION OF THE DRAWINGS

Embodiments of the invention will now be described by way of example with reference to the accompanying drawings in which:

FIG. 1A shows an optical image of a carbon nanotube sheet before treatment, suspended between copper terminals using silver paste.

FIG. 1B shows the carbon nanotube sheet of FIG. 1A after illumination according to an embodiment of the invention.

FIGS. 2A-2D show optical images of treated materials according to embodiments of the invention.

FIG. 3 shows an SEM image of the self-supporting CNT material before the laser treatment.

FIG. 4 shows an SEM image of the self-supporting CNT material after the laser treatment according to an embodiment of the invention.

FIG. 5 shows an SEM image of the self-supporting CNT material after the laser treatment and subsequent acid treatment in order to removes the exposed catalyst.

FIG. 6 shows a Raman spectrum on the self-supporting CNT material before the laser treatment.

FIG. 7 shows a Raman spectrum on the self-supporting CNT material after the laser treatment.

FIG. 8 shows the effect of a preferred embodiment of the invention on the microstructural alignment of a CNT-based material. Images shown as a, b, c and d are described below.

FIG. 9 shows the ‘before’ and ‘after’ effects of the Raman spectra from the atmospheric photonic process for different laser wavelengths.

FIG. 10 shows the effect of a preferred embodiment of the invention on the nanostructural sorting and alignment of a CNT-based material. Images shown as a, b, c and d are described below.

FIG. 11 shows electrical resistance behaviour with temperature, with electrical resistance normalized to room temperature electrical resistance, for the CNT material before and after laser treatment according to an embodiment of the invention.

FIG. 12 shows a schematic perspective view of photonic treatment of a CNT material sample in air, indicating translational movement of the laser beam relative to the CNT material.

FIG. 13 shows the effect of illumination of a single static area on the morphology and crystallinity of a CNT textile. The images around the circumference are high speed camera images of the oxidation flash from a single point illumination.

FIGS. 14a and 14b show TGA analysis results of CNT materials produced using butanol and toluene feedstock in a floating catalyst CVD process.

FIG. 15 shows an X-ray diffraction azimuthal scan for an embodiment of the invention, for use in determining the Herman orientation parameter.

FIG. 16A shows Raman spectra of a treated material according to an embodiment of the invention, in which the microstructure of the product is oriented parallel to the Raman laser polarization (black) and perpendicular (red). This provides an indication of the effect of alignment in the treated material on the polarized light Raman spectrum.

FIG. 16B shows Raman spectra as for FIG. 16A but for the carbon nanotube material before illumination treatment according to an embodiment of the invention.

FIG. 17 shows D:G values plotted against the fourth power of Raman excitation wavelength. As-is material (i.e. carbon nanotube material before treatment according to a method of an embodiment of the invention) does not yield a good fit and has a significant non-zero intercept. The materials according to embodiments of the invention have suitable linear relationships of D:G with the fourth power of the wavelength.

### DETAILED DESCRIPTION OF THE PREFERRED EMBODIMENTS, AND FURTHER OPTIONAL FEATURES OF THE INVENTION

Overview

Floating catalyst chemical vapor deposition is an easily industrialized, one-step production process that uniquely generates aligned single-walled carbon nanotube (SWCNT) or double-walled carbon nanotubes (DWCNT) textiles with individual CNT lengths magnitudes longer than competing processes. Even after extrinsic bulk imperfections are addressed, atomic scale defects inherent to the growth process could still limit prospects for competitive electrical transport. The preferred embodiments of the present invention seek to address this. The methodology presented here is particularly suited to these textiles, selectively removing amorphous carbon, and/or partly ordered non-tubular carbon, defective CNTs, and CNTs not forming a sufficient thermal pathway. In the preferred embodiments, what endures is an optically transparent SWCNT or DWCNT material (typically in the form of a film) with profound improvement in the microstructure alignment and, in regards to Raman spectroscopy, a D peak disappearing under the noise floor of the spectrometer while preserving the radial breathing modes. Furthermore, residual catalyst particles can be removed with a tailored non-oxidizing acid wash.

The basic procedure of irradiation of the material in air, followed by an acid wash, is shown to increase conductivity (e.g. up to tenfold) and then enables a simple acid treatment to increase conductivity several factors more. Cryogenic transport measurements show the effect of the new microstructure alignment, crystallinity, purity, and chemical treatment on the electrical transport.

Carbon nanotube (CNT) manufactured electrical cables are incrementally materializing as a disruptive technology in power transmission. Twenty-five years ago, what started as soot on a transmission electron microscopy grid evolved into bulk CNT cables exceeding copper and aluminium in terms of conductivity, current carrying capacity, and strength—if normalized by weight. These results are exciting but must be put into historical context. Over thirty years ago, other sp2 carbon forms, iodine doped polyacetelene and graphitic intercalation compounds, approached and, in the best cases, exceeded the conductivity of copper on its own accord without weight considered. Indeed, in 1984 intercalated graphitized carbon fiber was considered as a replacement for overhead power transmission lines on the grounds of its multifunctional strength and near-to-copper conductivity. In all these carbon materials, including the CNTs now, purity, internal alignment, and graphitic crystallinity are important in achieving highest virgin conductivity, as well as the highest conductivities after chemical treatment.

Single wall CNTs (SWCNTs) and double wall CNTs (DWCNTs) could be superior to the other bulk sp2 carbon forms, including large multiwall CNTs, in that transport may be uniquely both 1D (inherently suppressing phonon interaction, leading to substantially μm mean free paths) and intrinsically metallic (metallic resistance temperature dependence approaching absolute zero, without doping complications). Significant for electrical power transfer, researchers have demonstrated that quasi-one dimensional transport persists when combined together in a macroscopic assembly forming a textile. This attribute may yield superior bulk conductivity provided extrinsic factors such as purity, internal alignment, and graphitic crystallinity sufficiently evolve.

In the view of the inventors, floating catalyst chemical vapour deposition is the most scalable route for producing aligned, long length SWCNT and DWCNT textiles developed to date. It generates SWCNT and/or DWCNT textiles in sheet and fiber form where the individual CNTs are hundreds of times longer than CNTs in competing manufacturing processes. The CNT fiber conductivity, however, does not substantially outshine the competition. Crystal defects, as many as one every 10 nm, limits the room temperature mobility.

In the preferred embodiments of the present invention, a multi-step, photonic based post-process is presented which is particularly well suited to floating catalyst derived SWCNT and DWCNT textiles, substantially improving purity, internal alignment, and graphitic crystallinity. It is found that not all SWCNT and DWCNT materials may be successfully laser treated. The inventors speculate, without wishing to be bound by theory, that a high degree of pre-existing order may be required.

In the preferred embodiments of the invention, an incident laser beam continually passes over a stretched SWCNT (or double wall CNT) textile suspended by its ends so as not to be in contact with a substrate (supporting surface) at the treatment region. With each successive laser pass in air, material not forming a thermal conduit is incrementally removed. It is considered that the removed material is typically one or more of: amorphous carbon, partly ordered non-tubular carbons, defective CNTs, and CNTs not forming a sufficient thermal pathway. This treatment process may be summed up as natural selection—what survives is a transparent SWCNT (or DWCNT) film with substantially greater internal microstructure alignment, specific conductivity (tenfold increase), and a crystallinity which approaches the limits of instrument resolution (near elimination of the Raman spectra's D peak). Residual catalyst emerges to the surface and is easily removed subsequently with an acid bath. The significance of the work presented here is that: 1) it demonstrates the true potential of floating catalyst derived SWCNT textiles after substantial improvement of purity, alignment, and crystallinity; 2) it establishes a multi-step, scalable manufacturing process that may be integrated in a straightforward manner after production, or inline.

There has been some progress, reported in the literature, in the graphitization of multiwall CNTs. However, typically, graphitization has failed for SWCNTs. This includes previous attempts at laser annealing of CNTs. This is discussed in the following section of this disclosure. Proof of principle work is then presented, along with characterization techniques. Scale-up to arbitrarily long SWCNT textiles is then discussed, with continuous laser scanning. Without wishing to be bound by theory, the mechanics of the process are then discussed in terms of the differences from other SWCNT annealing and purification techniques.

### Further Background

Graphitization is the high temperature, inert annealing (2500 to 3500° C.) that graphite and carbon fiber requires for particularly high mobility and electrical conductivity. It reduces impurities, heals crystalline point defects, as well as enhances internal microstructure order. Crystal grains grow and stacked graphene planes align with regular ABAB stacking, leading to shrinking graphene plane separation and an increase in bulk density. At first glance, graphitization of CNTs is an obvious course of action and indeed has been successfully applied to the multiwall variety. Transmission electron microscopy shows that the initially wavy and disordered walls of an as-produced multiwall CNT straighten after graphitization. Thermo-gravimetric analysis reveals graphitization increases oxidation temperature a couple of hundred degrees centigrade, indicating removal of defects that are the first points of oxidation. Multiwall graphitization has been shown to improve room temperature conductivity from 10 to 200 kSm⁻¹, to increase thermal conductivity 2.5 to 22.3 W K⁻¹ m⁻¹, and to improve a charge carrier's mean free path from about 0.3 μm to about 2 μm. Raman spectroscopy on graphitized multiwall CNTs shows a narrowing of the G peak and a shift to higher energy. D:G, the ratio between the Raman spectra's D peak and G peak and a prevalent indicator of graphitic crystallinity, improved from 0.769 to 0.270 (Kajiura et al. (2005)).

SWCNT graphitization is, however, another story. Not even approaching typical graphitization temperatures, there are multiple reports revealing SWCNTs coalescing into larger SWCNTs beginning at about 1400° C. in inert backgrounds. By about 1800° C. these larger SWCNTs start transforming into multiwall CNTs. By 2400° C. it was found all CNTs transformed into multiwall CNTs, and in some cases even graphitic carbon ribbons. Double-wall CNTs performed better and were structurally stable up to 2000° C. Researchers verified SWCNT coalescence with transmission electron microscopy and Raman spectroscopy, where shifts of the Raman radial breathing modes to lower energy indicate conversion to wider diameter tubes. Upon conversion to multiwall tubes the radial breathing modes disappear. SWCNTs, and to a lesser degree DWCNTs, are peculiar to other sp2 carbons considering their small cylindrical diameter and curvature induced internal stress. This makes them notoriously vulnerable to oxidation, chemical treatment, and, unfortunately, also includes typical graphitization annealing.

The internal stresses that prevent typical graphitization treatment, however, potentially render defects easier to heal. Defects in CNT crystal structure are not stationary in a fixed location and are in fact highly mobile. First principle modelling shows that single vacancy defects in SWCNTs become mobile at about 100-200° C. and transmission electron microscopy found multiwall CNT defects are perturbed by thermal fluctuations and will travel up heat gradients, at a speed 80 nm s⁻¹. Beyond simply moving defects, another microscopy study directly witnessed healing of double-wall CNT defects. The defect healing rate increases strongly with temperature with the healing rate saturating at about 225° C. Thus, a SWCNT equivalent of graphitization quite possibly requires much lower temperatures then more planar graphite structures. Inert annealing of SWCNTs well below typical graphitization temperatures has been attempted at 1000° C. and lead to an improvement in the Raman spectra's D to G ratio, at the best Raman excitation wavelength, from 0.18 to 0.059.

Instead of using typical furnaces for heat treatment, annealing with laser illumination is an alternate heat source with inherently faster heating/cooling rates and selective heat zones allowing a degree of control not found with furnaces. In itself, laser annealing of CNTs is not a new concept. The most successful laser processes involved illuminating SWCNTs in air, where often the annealing laser was also a probe for Raman spectroscopy—see Corio et al. (2002), Huang et al. (2006), Mahjouri-Samani et al. (2009), Souza et al. (2015), Marković et al. (2012), Maehashi et al. (2004) and Mialichi et al. (2013). Experimental parameters between these Raman in-air studies varied significantly. Laser wavelengths spanned from ultraviolet to infrared, and the most successful average intensities ranged from 1 to 100 kWcm⁻². Total treatment time lasted tens of seconds to hours. Despite the parameter spread, the outcome of often was the same—that is, a modification of the Raman spectra's radial breathing modes. An early study alluded this effect to selectively oxidizing smaller diameter CNTs due to their greater chemical activity (Corio et al. (2002)). Other studies determined that this is not exactly the case, and that the laser treatment selectively oxidizes away metallic SWCNTs from the interaction of free charge carriers with the laser light (Huang et al. (2006), Mahjouri-Samani et al. (2009) and Souza et al. (2015)).

Beyond the changes of radial breathing modes, air laser treatment of SWCNTs generally leads to some improvement in D:G—indicating a crystallinity enhancement and/or removal of amorphous carbon. Sometimes D:G improved substantially; in a case of unaligned SWCNTs it was beyond an order of magnitude from 0.67 to 0.04 (Souza et al. (2015)). In another case for unaligned SWCNTs, there was the removal of the D peak (Zhang et al. (2002)). In both of these examples, before laser treatment, the SWCNTs were grown with either the laser ablation or arc discharge methods. These growth processes over a very brief time expose the SWCNTs to higher temperatures (above 1700° C.) than floating catalyst derived textiles. The D:G improvement from their laser annealing could be explained by removal of amorphous carbon, leaving behind SWCNTs that are already very crystalline.

Moving away from treating SWCNTs in air, laser annealing SWCNTs in an inert atmosphere such as vacuum, nitrogen, or argon has only led to marginal improvement of the crystallinity (Mialichi et al. (2013)). Researchers noticed that significant heat is lost with convection to the inert gas background compared to the case with vacuum. A SWCNT sample laser heated to 1000° C. in vacuum, for example, would under the same illumination conditions in nitrogen experience only a temperature of 250° C. Laser treating multiwall CNTs, in either air or inert background, has mostly led to only marginal improvement or to deterioration. An exception is aligned multiwall CNT yarn suspended in vacuum and heated by a sweeping CO₂ laser (3.8 kW cm⁻² over about 20 ms per laser pass) (Liu et al. (2012)). Conductivity increased about 50% from 42.5 to 65 kSm⁻¹ and D:G ratio improved from 0.45 to 0.08. Note that there was not a clear change in the microstructure or fiber diameter and the yarn toughness decreased appreciably.

A thoroughly discussed parameter in CNT laser annealing is laser wavelength. CNTs in general have four physically distinct electromagnetic absorption mechanisms belonging in the THz, infrared, visible, and ultraviolet regions of the spectrum. Starting with mechanisms in the THz to infrared regime, the plasma frequency of CNT materials ranges from approximately 55.6 μm (22.3 meV/180 cm⁻¹) to 12.4 μm (100 meV/806 cm⁻¹). Also in this regime, a broad absorption peak exists for both SWCNTs and multiwall CNTs near 100 μm (12.4 meV/100 cm⁻¹). The basis of this absorption peak has been a source of controversy—attributed to either the small bandgap formed by the curvature of the graphene plane into a CNT or plasmon oscillations along the length of a CNT. Recent results indicate the latter. While this absorption peak is centred at a wavelength too large for most practical lasers, the peak is broad enough to be a factor for infrared lasers. In regards to laser annealing CNTs in the infrared, a study (Markovic et al. (2012)) evaluated CNT annealing with multiple wavelengths from visible to infrared. It was found that small wavelengths probed the surface of unaligned SWCNT materials (168 nm penetration for 532 nm laser line) and longer wavelengths penetrated deeper into the bulk (331 nm penetration for 780 nm laser line). This finding supports that longer wavelengths are a perhaps better choice to fully impact the material in a homogeneous manner.

For the higher energy regions of the spectrum, SWCNTs display well-defined visible absorption peaks from the electronic transitions between von Hove singularities. The particular locations of these peaks are chirality dependent and are not present for multiwall CNTs generally. Due to a distribution of chiralities and the effects of SWCNT aggregation/bundling, the absorption peaks will broaden and merge. In regards to laser annealing, at least one study claimed their laser struck a resonance with a van Hove singularity (Maehashi et al. (2004)). The radial breathing modes in their Raman spectra indeed changed after laser illumination. This effect, however, is also explained by selective oxidation of small or metallic tubes, which has been observed previously (Corio et al. (2002), Huang et al. (2006), Mahjouri-Samani et al. (2009) and Souza et al. (2015)) and was not discussed in their paper. Both multiwall CNTs, SWCNTs as well as graphite and graphene, have a prominent absorption band in the ultraviolet regime centred at 248 nm (5 eV) due to resonance of the π-plasmon. Researchers showed laser annealing at this wavelength had a particular purification effect where amorphous carbon was selectively oxidized away, sparing the SWCNTs (Hurst et al. (2010) and Gspann et al. (2014)).

US 20130028830 discloses some aspects of work carried out on laser annealing of CNTs in an inert argon environment. This approach was shown to lead to densification of the material. Additionally, the treatment disclosed in US 20130028830 forces residual catalyst to the surface. The process of US 20130028830 does not remove significant amount of material from the sample treated.

In the academic literature which discloses the laser treatment of single wall CNTs in air, there emerges a picture of improvement in graphitic crystallinity but another effect seems to be the removal of metallic SWNTs or small diameter SWNTs. In all of the studies mentioned, the SWNT film is supported on a substrate and is illuminated by the laser at very high laser power and dwell times (i.e. high laser fluence). The literature seems to suggest that longer wavelengths penetrate deeper into the material.

Materials Under Test and Set-Up

In the preferred embodiment of the present invention, the treatment process selectively removes non-conductive CNTs, partly ordered non-tubular carbons, and amorphous carbon. Where the self-supporting material at the start of the process is an opaque film, the treatment process renders it transparent, where the CNT microstructure is significantly more aligned. To the knowledge of the inventors, there is no other disclosure of a similar effect. In particular, the radial breathing modes of the Raman spectroscopy do not change after treatment. This indicates that the SWCNT/double-wall CNTs distribution has not changed despite being well above their oxidation temperature. This too is a new result whereas other, more primitive oxidative laser annealing altered if not destroyed this distribution. The inventors have found that the effect is accompanied by a profound increase in conductivity, purity and graphitic crystallinity. It is found that the technique has particular applicability to CNT-based materials manufactured by a floating catalyst CVD method.

The primary material under test was somewhat aligned SWCNT/DWCNT textiles generated from various floating catalyst chemical vapour deposition recipes. The CNT generation process is described in Koziol et al. (2007) and Gspann et al. (2014). Briefly, a liquid carbon source, such as toluene or n-butanol, is evaporated and mixed with sublimed ferrocene, the catalyst precursor, and thiophene, the reaction promoter—all within a hydrogen gas background. The gas mixture is passed through a tube furnace at about 1300° C., forming an elastic CNT cloud. The CNT cloud is directly extracted out of the furnace by mechanical means on to a spool where its winding rate dictates the degree of microstructure alignment. Unaligned CNT buckypaper commercially obtained from NanoIntegris was also investigated.

Aligned CNT textiles were stretched between two scaffolds such that the film was elevated and supported only at its ends with tape. The treatment region of the textile was not in contact with any underlying substrate. As-is film thickness ranged from approximately 5 μm to 15 μm and the microstructure alignment was typically in the long direction of the cut film.

A collimated, linearly polarized, 10 μm wavelength pulsed laser beam illuminated the suspended film directly overhead with the following typical settings: 40 W average power, 5 kHz pulsed repetition rate, 20% duty cycle. The beam profile was Gaussian with a 1/e² diameter of 10 mm. This yielded an average intensity of 50 W cm⁻². Per pulse, the peak intensity and fluence were 250 W cm⁻² and 0.25 J cm⁻² respectively. These are the general, not necessarily optimized “sweet spot” parameters that should be assumed if not explicitly stated otherwise.

After atmospheric photonic processing, the primary characterization tool was a Bruker Senterra Raman microscope with 532 nm, 633 nm, and 785 nm laser lines. Incoming laser light was randomly polarized and the 4× objective was used to mitigate signal distortion from heating. The laser accumulation time and intensity also were kept as small as practical to minimize heating; we verified that the accepted spectrum was largely independent of these laser heating parameters. The spectra depicted are averages over at least five different film locations with standard deviation well below the measured values. Every spectra is normalized by the G peak and has been baseline corrected. D:G was calculated by integrating peak areas, which is a more useful metric accounting for peak width changes, rather than simply considering peak height. In cases where the D peak was very small, we found plotting the intensity logarithmically helped with peak boundary identification. The G peak, Raman spectroscopy's well-established prominent peak found with graphitic materials, is typically centred at approximately 1582 cm⁻¹ independent of Raman laser excitation wavelength for undoped CNT materials. The width at full width half maximum can vary considerably although a width of 500 cm⁻¹ is common. The integration of the peak areas is carried out between peak limits established by where the peak meets the base line. The exact position of the D peak depends on the CNT material and the excitation wavelength, although peaks centred at approximately 1350 cm⁻¹ (for 532 nm excitation) and 1300 cm⁻¹ (for 785 nm excitation) are typical.

Scanning electron microscopy was accomplished with a FEI Nova NanoSEM. Evolution of the oxidation flash from the laser CNT material interaction was recorded with a high speed camera (36,000 frames per second) and the CNT textile temperature was measured with a pyrometer. Thermo-gravimetric analysis was accomplished with a TA instruments Q500 in bottled air with a dynamic heating rate. To determine conduction mechanisms, cryogenic resistance versus temperature was measured in a standard four probe configuration and gradual submersion into a liquid helium Dewar. Probe current was 10 μA.

Next is a discussion of the effects of the laser/CNT/air interaction at a material point followed by a consideration of continuous scanning, demonstrating scale-up.

The Photonic Procedure

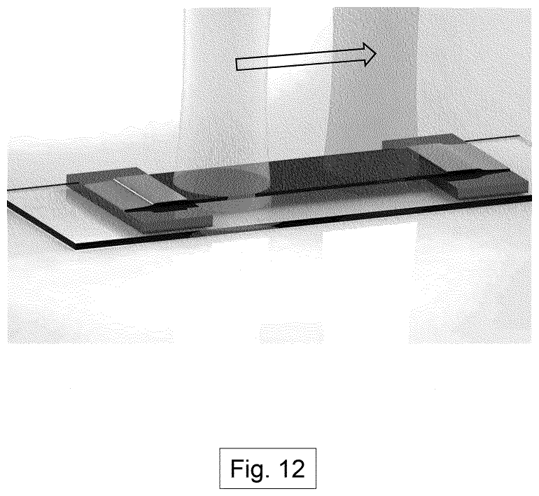

FIG. 12 shows a schematic perspective view of photonic treatment of a CNT material sample in air, indicating translational movement (see arrow) of the laser beam relative to the CNT material. A treatment region of the CNT textile is elevated off the substrate by suspending the textile from its ends. The laser sweeps across the surface leading to selective oxidation. Surviving CNTs have substantially improved chirality, micro-structure alignment, and residual catalyst migration to the surface.

As an initial experiment, the CNT textile was illuminated without translational movement of the laser beam. It is found that such single point illumination does not yield the best results, although its relative simplicity makes the fundamental photonic effect easier to study.

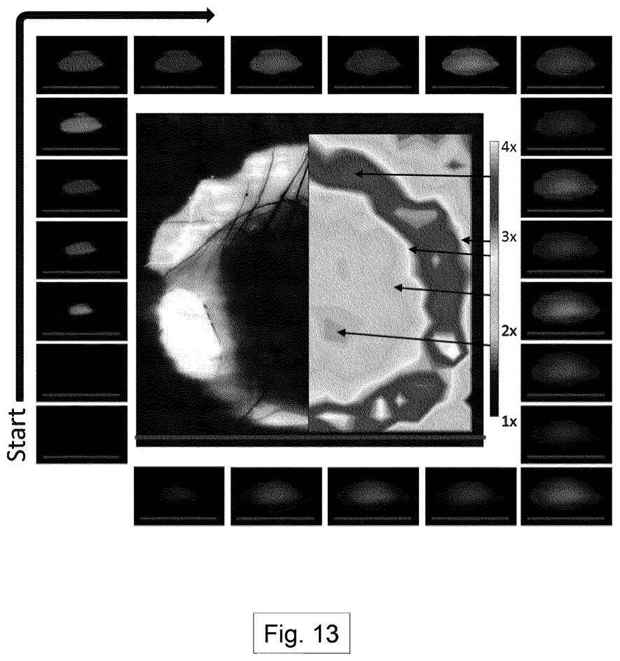

FIG. 13 shows the effect of static illumination for a 150 ms duration shot, which is a train of 750 individual laser pulses. The sample here is considerably larger than the beam diameter so that thermal edge effects are not in play. The optical microscope image (left hand side of the central part of FIG. 13) shows a transparent annulus region where it is apparent that most of the material has vaporized. The Raman map overlay of relative D:G reduction factor (right hand side of the central part of FIG. 13) shows a three to four fold crystallinity improvement in the annulus region and a two to three fold improvement in the inner region. This is the first indication of a general theme that transparency equates to, among several parameters, superior crystallinity.

In more detail, the right hand side of the inner part of FIG. 13 shows a Raman map of the annulus oxidation region produced by a 150 ms application of the laser, comprised of a 5 kH pulse train. Here, the map shows relative reduction factor in D:G, and in this particular example the best improvement is only a factor of four. An optical microscope photograph (left hand side of the central part of FIG. 13) shows the improved annulus region is optically transparent, indicating most of the SWCNTs in the improved region burned away. In the original image, false colour is used, and so selected regions of the image are mapped onto the scale, to guide the eye. The perimeter of FIG. 13 shows a sequence of images captured via high speed camera showing the evolution of the laser heat zone combined with the oxidation reaction flash. Note the camera is at an angle that tilts the perspective. These displayed images are at 277.5 μs intervals, an image for approximately every individual laser pulse. The horizontal bar indicates 10 mm.

This annulus form shown in FIG. 13 is unexpected because the laser beam intensity has a Gaussian distribution. The high speed camera images shown around the perimeter of FIG. 13 show the high intensity flash from the laser interaction growing from the inside outward (verifying the Gaussian profile) and reaching the beam diameter size in approximately 3 ms (or 12 laser pulses). Also by this point, the annulus region (and hence the critical CNT oxidation) is also apparent. When watching the motion video, the expanding flash is composed of rhythmic heating of the 5 kHz laser pulses, as well as a constant non-cyclic component that is assumed to be self-sustained oxidation. Pyrometer measurements indicate sustained temperatures at 1400° C., almost three times the temperature required to initiate oxidation. Note that pyrometers measure black body radiation and light caused from the electronic transitions in exothermic reactions would alter the temperature measurement. Regardless, the visual intensity of the white flash qualitatively indicates temperature almost certainly above the SWCNT oxidation threshold and this is confirmed by the transparency of the annulus region. There is more than sufficient temperature and fuel supply available for oxidation over the entire illuminated region however, so the striking differences between the transparent annulus and opaque inner zones are perhaps best explained by oxygen availability. Also particularly noteworthy, the oxidation and resultant vaporization process terminates in the first 3 ms (approximately 12 laser pulses) of a 150 ms duration shot. This important observation drove development of the scale-up approach.

Based on this initial work, it is found that when there is insufficient laser fluence, there is no substantial effect on the visually appearance of the microstructure of the material or on the properties of the material as determined by Raman spectroscopy. On the other hand, too high a laser fluence simply burns holes in the material. The laser treatment can be carried out at intermediate operating conditions such that the initially opaque CNT textile becomes transparent and it is found that this usually indicates superior properties.

The inventors investigated variables such as film thickness and laser polarization. These changed the precise preferred operating parameters to some degree, but did not result in a fundamental, dramatic consequence.

The inventors also tested a 1 μm laser, an order of magnitude lower wavelength, and this too yielded similar results in terms of microstructure and Raman spectra to those discussed above. This wavelength independence supports the view that the atmospheric photonic process is thermally driven oxidation without reliance on a particular absorption mechanism or electronic transition.

It was found that the CNT film should not be in thermal contact with a substrate at the treatment region. In this embodiment, this was achieved by elevating the sample from the substrate by suspension from its ends. Highlighting the relevance of heat transport, it was found that regions in thermal contact with a substrate, such as a CNT film supported by a glass slide, will not experience the intense white oxidation flash or any substantial material enhancement.

The photonic process was carried out on unaligned SWCNT buckypaper commercially obtained from NanoIntegris. It was found that this material did not respond in the same way to the atmospheric photonic process. Such buckypaper is a highly purified SWCNT material with residual catalyst and amorphous carbon less than 3% and 2% respectively, as stated by the supplier. They however lack any internal alignment and are composed of SWCNT lengths no longer than about 1 μm.

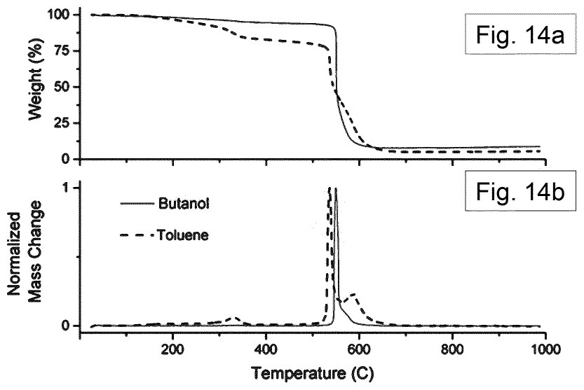

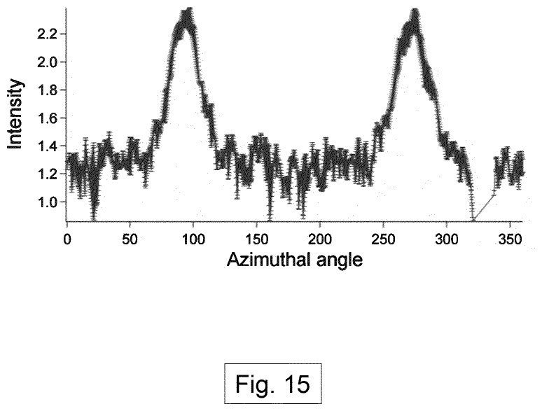

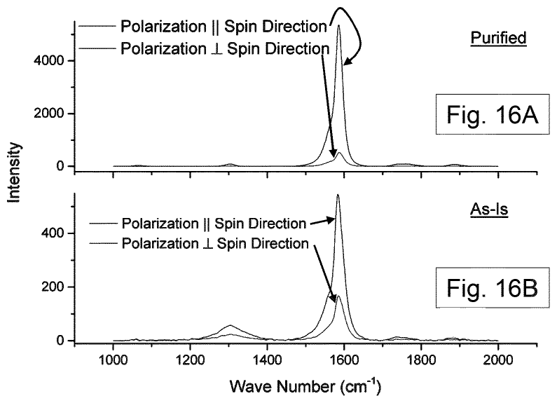

In the experiments carried out by the inventors, successful outcomes were obtained with textiles composed of partly aligned, long length CNTs made using floating catalyst chemical vapour deposition. In one such process, a recipe based on a n-butanol carbon feedstock produced CNT textile which did respond well to the laser treatment in terms of improvement in Raman crystallinity and microstructure alignment. However, another recipe using a toluene feedstock did not experience any Raman crystallinity improvement, although still had microstructure alignment. Thermo-gravimetric analysis (see FIG. 14) reveals the toluene-derived material's greater carbon species diversity. The temperature derivative of weight, for example (FIG. 14b), shows the oxidation temperature for toluene derived CNTs as two broad peaks at about 550° C., contrasting with n-butanol's single sharp oxidation peak.

In more detail, FIGS. 14a and 14b show the results of thermo-gravimetric analysis on as-is material spun from n-butanol and material spun from toluene. FIG. 14a shows the mass in percentage and FIG. 14b shows the normalized mass derivative with respect to temperature showing species oxidation temperatures.

The gradual weight reduction up to CNT oxidation indicates the amount of amorphous and oligomeric carbon present. This is 20% in terms of the total weight for toluene, compared to 6% for n-butanol. The toluene material has a small oxidation peak at about 325° C. that point to oligomeric carbon, which coats and cross-links the CNTs. Without being bound by theory, the inventors speculate that the n-butanol derived material has a greater underlying graphitic crystallinity then the toluene derived material, as indicated by Raman spectroscopy after laser treatment. Additionally, the residual Fe content is somewhat higher in the n-butanol derived sample which will also have an effect in triggering vaporization events.

With this better understanding of the basic effects and requirements of photonic processing in an oxidative atmosphere such as air, we now consider a more complex process beyond point illumination that demonstrates uniform treatment of an arbitrarily long CNT textile, as well as superior improvement in crystallinity and microstructure alignment. The high speed camera images in FIG. 13 showed that the critical oxidation process concludes after approximately 3 ms, or 12 laser pulses, and is relatively quick compared to the full duration of the point illumination shot. Rather than discretely starting and stopping the laser to treat a long sample, the inventors found that continuously sweeping the laser quickly across a suspended CNT textile in air leads to a better and more uniform outcome. Approximately 350 mm s⁻¹ was the fastest practical scan speed available in this set-up. Typically, initial transparent regions appear after several laser sweeps and then the next laser pass typically renders the entire sample uniformly transparent. The actual number of required passes is sample dependent and particularly thin CNT films may require only one pass. Additional laser passes beyond uniform transparency incrementally vaporises more material with little or no gains in quality. The width of the SWCNT textile film did not have a major impact on the outcome, except wider films suffered greater macroscopic tears from internal stain after treatment. The initial, as-is microstructure alignment should be substantially parallel to the direction of the laser scanning. Rastering the laser over a film cut against the microstructure grain leads to a mechanically weak and inhomogeneous outcome.

Compared with the properties of the as-made CNT material, the effect of the treatment of the material using an embodiment of the invention has been found to be an improvement in the alignment, crystallinity, and purity of CNT material to the extent that there is a dramatic increase in the electrical and thermal conductivity of the material. Initial results indicate an order of magnitude increase in specific conductivity.

In a preferred embodiment of the present invention, therefore, the laser beam is continuously rastered along the CNT-based material in air. It is considered that this burns away material that is not part of a high thermally conductive pathway. The remaining CNTs have a five-fold increase in crystallinity as indicated by Raman spectroscopy and significantly enhanced alignment as indicated by SEM.

Residual catalyst is forced to the material's surface where it can be easily removed by acid treatment. Also, the material becomes transparent as a result of the decreased density. In effect, the process provides a sorting/distillation that preserves highly conductive CNTs and burns away the remainder.

It is considered that the laser process makes the material transparent by reducing the density of the material significantly. The treated material may therefore be used for applications requiring thin and flexible electrical conductors, such as for touch screens.

The inventors consider that the preferred embodiment of the present invention can be considered to provide a distillation process that sorts out the most conductive CNT pathways and removes the rest. The process also has the effect of increasing the alignment and crystallinity of the remaining CNTs.

It is considered that the process should be carried out in a suitably oxidative environment. An air environment is considered to be suitable and practical. The inventors initially expected this would completely vaporize the material. To their surprise, this was not the case with the material becoming transparent, internally aligned, and much more crystalline.

It is also considered that the material should be suspended, in the sense that the portion being treated should not be in direct thermal contact with a substrate.

The present invention has particular applicability to CNT-based materials manufactured using the floating catalyst CVD method, as pioneered at the University of Cambridge.

It is considered that the effects of the invention are seen well when the laser is quickly and continuously rastered over the material, compared with a step-wise approach where the laser is pulsed incrementally along the material.

It appears that varying the laser parameters such as laser wavelength and polarization does not have a systematic and substantial effect. However, variations in the laser power or dwell time does have an effect. Too little energy delivered to the material results in no effect, whereas too much vaporizes the entire treatment zone.

The inventors have also found that the invention is not necessarily limited to the use of a laser to deliver energy to the material. The inventors have found that intense white light flashes, such as from a photographic flash, also provides the same effect in terms of microstructure alignment and crystallinity. Thus, the use of a laser is not necessary and all that is needed is an intense light source. This is supported by the comment above that laser wavelength and polarization do not substantially affect the results.

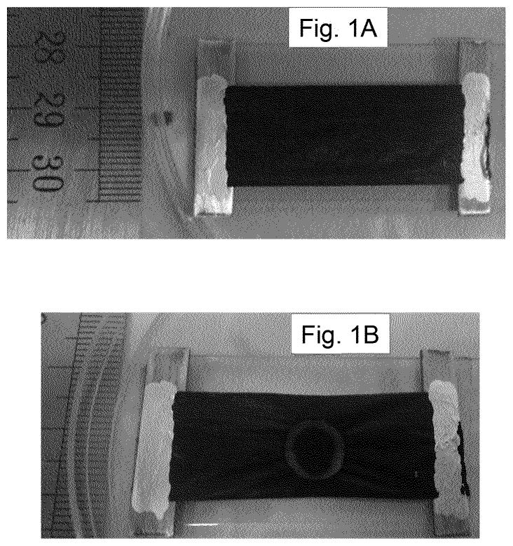

FIG. 1A shows an optical image of a carbon nanotube sheet before treatment, suspended between copper terminals using silver paste. The sheet has footprint dimensions of about 15 mm×50 mm.

FIG. 1B shows the carbon nanotube sheet of FIG. 1A after illumination according to an embodiment of the invention. The effect of the illumination is visible as an annular ring, even though the illumination portion was circular, rather than annular. As can also be seen from this image, the material has undergone a slight dimensional shrinking, plainly concentrated at the annular ring.

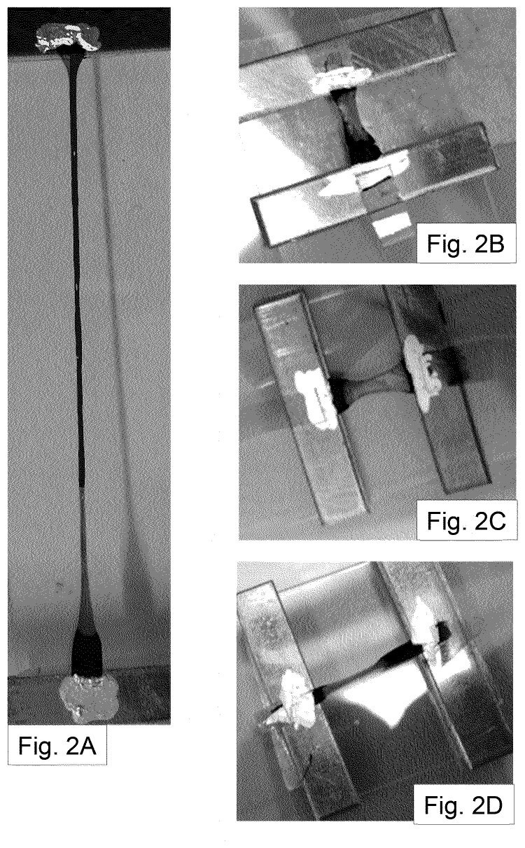

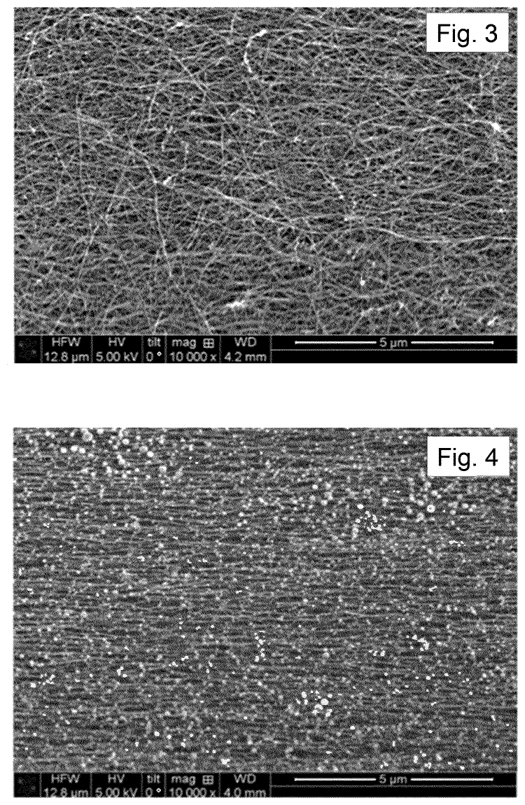

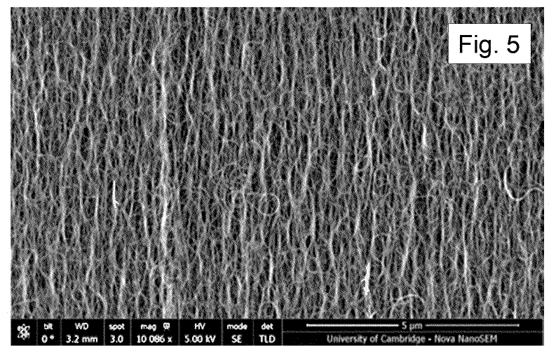

FIG. 2A shows an optical image of a treated material according to an embodiment of the invention. The original lateral dimension of the untreated material can be seen close to the terminals and the much reduced lateral dimension of the treated material can be seen in the central part, along with the increase in light transmission through the treated material.

FIGS. 2B-2D also show optical images of treated carbon nanotube materials according to embodiments of the invention.

FIG. 3 shows an SEM image of the self-supporting CNT material before the laser treatment. Viewed by eye, the image shows a small degree of alignment.

FIG. 4 shows an SEM image of the self-supporting CNT material after the laser treatment. As can be seen, there is now strong alignment and catalyst particles have been forced to the outside.

FIG. 5 shows an SEM image of the self-supporting CNT material after the laser treatment and subsequent acid treatment in order to removes the exposed catalyst. As can be seen, the strong alignment remains. Note that the orientation of the sample in FIG. 5 is different to the orientation of the samples in FIGS. 3 and 4, resulting in a different apparent alignment direction.

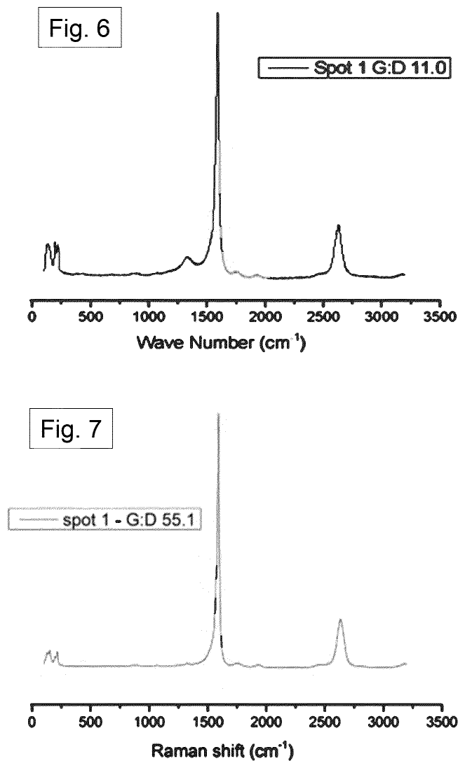

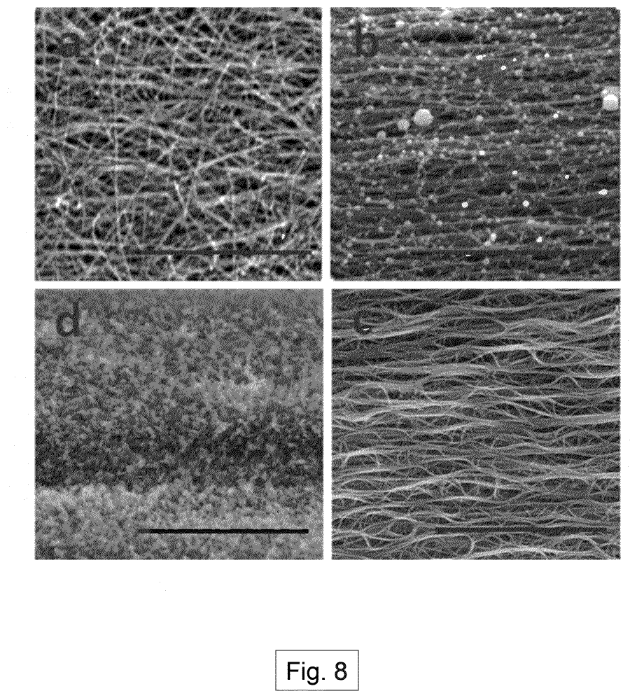

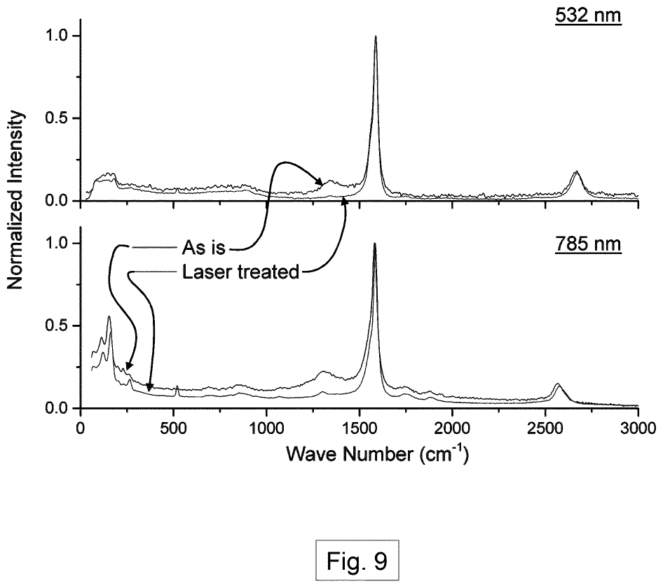

FIG. 6 shows a Raman spectrum on the self-supporting CNT material before the laser treatment. A G:D ratio of 11 is already a high value compared to other CNT materials. The peak on the left shows RBMs which indicate the presence of single wall CNTs.

FIG. 7 shows a Raman spectrum on the self-supporting CNT material after the laser treatment. There is a dramatic improvement of the G:D ratio to 55. Also, the RBMs remain and indicate the survival of single wall CNTs/double-wall CNTs, which are the most chemically active of CNTs and the easiest to burn. This is therefore counter-intuitive when taking the disclosure of the prior art into account, where laser treatment in air would be expected selectively to remove the SWCNTs.

FIG. 8 shows further ‘before’ and ‘after’ SEM images of the effect of the scaled-up atmospheric photonic process. In the as-is, ‘before’ image (FIG. 8a) there is some alignment in the horizontal direction with bundles of various diameters. The ‘after’ image (FIG. 8b) shows distinct alignment in the horizontal direction with improved bundle diameter standardization. Iron catalyst dots the landscape which we attribute to the remains of vaporized CNTs. A simple non-oxidizing acid wash of 37% HCl quickly removes the catalyst (FIG. 8c). Most catalyst is consumed after immediate HCl application and all is gone within an hour. Bundle diameter also increases. The acid's impact to crystallinity is minimal provided the HCl is neutralized with water within the hour. Longer duration acid baths on the order of days tended to degrade the Raman D:G to a degree. The inventors found that applying acid with the CNT film still suspended and fixed at its ends condenses the transparent film into an opaque fiber and assists in maintaining the high degree of microstructure alignment. After the acid wash, neutralization, and drying, the sample was typically about 10% its original weight. Along with the visible transparency, this shows that the atmospheric photonic process is a sorting procedure where not only catalyst, amorphous carbon, and other non-CNT forms are removed, but most CNTs are sorted out as well.

In more detail, FIG. 8 shows representative scanning electron microscopy photographs at 5 kV of the CNT material through various stages of the photonic process. The scale bar indicates 2 μm. FIG. 8a shows as-is CNT textile. FIG. 8b shows the textile directly after atmospheric photonic processing. FIG. 8c shows the textile after removal of the residual catalyst with an acid wash. FIG. 8d shows the textile after treatment under inert conditions with too high a laser fluence, having the effect of transforming the CNTs into amorphous carbon.

FIG. 9 shows the ‘before’ and ‘after’ effects of the Raman spectra from the atmospheric process for different laser wavelengths. The D peak nearly disappears for the 532 nm laser line and diminishes significantly for 785 nm. In terms of D:G, this is an improvement from 0.094 to 0.015 (532 nm) and 0.117 to 0.054 (785 nm). FIG. 9 shows the preservation of radial breathing modes (RBMs), although there may be some limited peak reduction present. This preservation contrasts other air laser annealing studies (Corio et al. (2002), Huang et al. (2006), Mahjouri-Samani et al. (2009) and Souza et al. (2015)) which primarily targeted small diameter and metallic SWCNTs leading to substantial radial breathing mode modification. Considering that about 10% material by weight remains after the full treatment, the fact radial breathing modes survive gives credence to atmospheric processing as a SWCNT purification technique.

In more detail, FIG. 9 shows Raman spectra showing near removal of the D peak (532 nm laser line) or reduction (785 nm laser line) after atmospheric photonic processing, as well as narrowing of features in general. Black is the as-is ‘before’ and red is the atmospheric photonic processed material ‘after’. The radial breathing modes are preserved despite flash oxidation vaporizing a significant majority of the carbon material. The inventors observed the absolute Raman signal magnitude typically multiplies by a factor of four after treatment. This is attributed it to removal of sp3 carbon, which has a substantially smaller Raman cross-section then sp2 carbon.

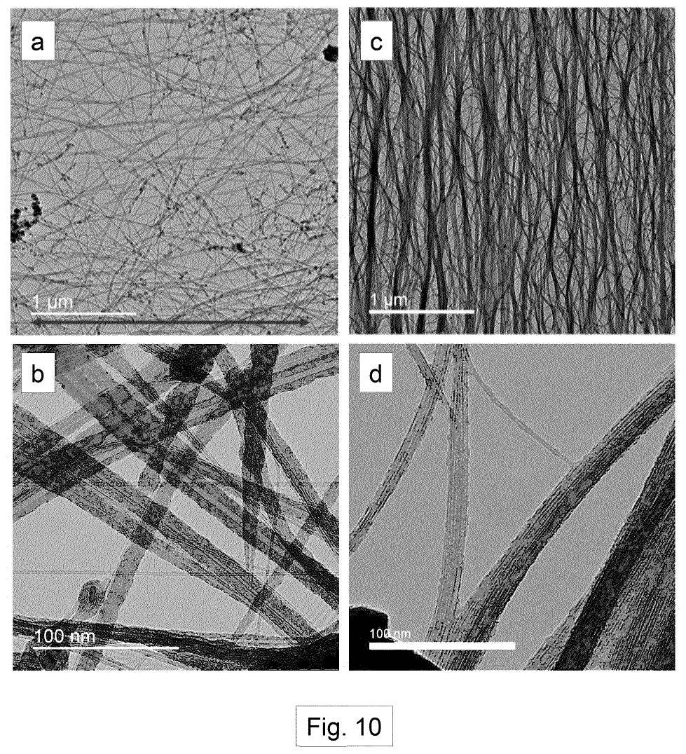

FIG. 10 shows TEM images of the treated CNT material. FIG. 10a shows a TEM image of the material before photonic processing. FIG. 10b shows the same material at higher magnification. In FIG. 10a, the arrow indicates the direction of alignment of the material, corresponding to the direction of extraction of the material from the floating catalyst CVD process furnace. In FIGS. 10a and 10b, the material comprises multi-wall and single wall CNTs mixed with catalytic and carbonaceous impurities. FIG. 10c shows a TEM image of the material after photonic processing. FIG. 10d shows the same material at higher magnification. In FIG. 10c, the arrow indicates the direction of alignment of the material, corresponding to the direction of extraction of the material from the floating catalyst CVD process furnace and the direction of scanning of the laser during the photonic processing. In FIGS. 10c and 10d, the material has a high degree of microstructure alignment and differs further from the as-is material in terms of the removal of non-conductive channels.

Electronic Transport

Atmospheric processing leads to substantially improved purity, crystallinity, and microstructure alignment, with the objective to improve the electrical transport. Conductivity is a poor metric for a textile; specific conductivity addresses differences in textile density. The as-made specific conductivity of the CNT textile was 100 m² kg⁻¹Ω⁻¹ with a standard deviation less than 10%. After laser treatment in air, followed by the acid washing procedure, specific conductivity increases up to five to ten fold (500 to 1000 m² kg⁻¹Ω⁻¹, across about a dozen samples measured).

Floating catalyst derived CNT textiles typically reside on the metal side of the insulator to metal transition. Here, delocalized charge carriers extend across CNT structures and most of the overall loss originates from tunnelling between these structures. Measuring resistance versus temperature discerns between this extrinsic transport (governed by CNT junctions, misalignment, voids, impurities and other large scale textile disorder) and the intrinsic transport from the SWCNTs themselves. The Fluctuation Induced Tunnelling model (left term of equation 1) describes this extrinsic contribution and leads to a resistance that increases with decreasing temperature, although approaches a finite value at absolute zero:

$$R ( T ) = {R}_{FIT} exp [ \frac{{T}_{1}}{{T}_{2} + T} ] + AT \qquad Equation 1$$

where R_{FIT}, T₁, and T₂ are fitting parameters and T is temperature. In some cases, the intrinsic contribution is modelled with a standard metallic term AT where A is a fitting parameter. In cases with better internal alignment, the standard metal term is replaced by a quasi-1D metallic term as shown in equation 2:

$$R ( T ) = {R}_{FIT} exp [ \frac{{T}_{1}}{{T}_{2} + T} ] + B exp [ - \frac{{T}_{Phonon}}{T} ] \qquad Equation 2$$

where B is a fitting parameter and T_{Phonon} is the characteristic temperature for temperatures below which phonon interaction is suppressed in quasi-1D conductors.

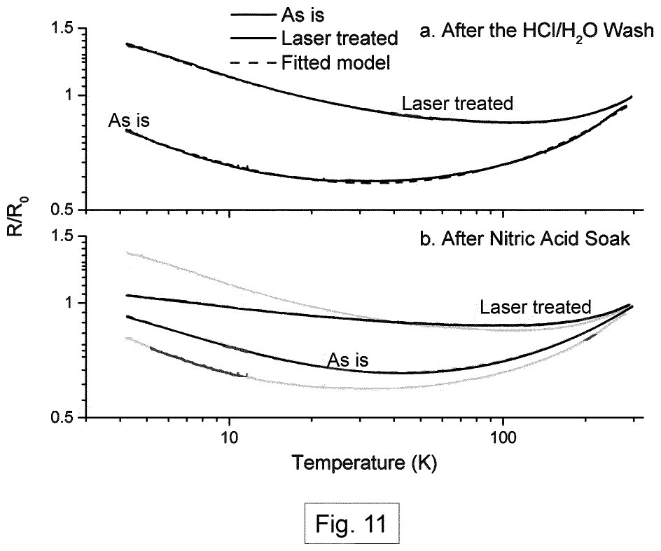

FIG. 11 shows the resistance versus temperature results for two samples: 1) an as-is sample (designated ‘as-is’), and 2) a sample after atmospheric photonic processing. Laser treated samples were given an HCl wash, followed by H₂O neutralization, and then drying. The primary intent here was to remove iron catalyst that is known to limit transport. Unintentional benefits from the acid wash however may include the film condensing down to a densified fiber as well as surface chemistry modification, both known to enhance charge transfer across CNT bundles. To ensure an appropriate control for comparison, the as-is sample was subjected to the same acid wash procedure.

FIG. 11a shows the resistance versus temperature plots for the two samples after the HCl/H₂O wash. For both samples both metallic and semi-conducting temperature dependent regions are apparent. For the laser treated sample, however, the semi-conducting region is substantially larger than the metallic region. On the other hand, the as-is sample has dominant metallic temperature dependence. It is found that equation (1) with the standard metallic term fits well to the raw material while equation (2) does not. The opposite was true for the photonic processed material; the quasi-1D conduction term fit decisively better than the standard metallic term.

Using the fitted parameters of equations (1) and (2) (shown in Table 1), the ratio of the intrinsic and extrinsic contributions at room temperature can be determined. For the as-is material, this division is split in the middle, 49% intrinsic/51% extrinsic. As expected with the visibly large semi-conducting region, the resistance of the laser treated material is extrinsically weighted with 18% intrinsic/82% extrinsic (for the basic air procedure). The change from an even split to principally extrinsic resistance may be explained by either a net conductivity increase of the intrinsic CNT structures or, alternatively, a decrease in conductivity of extrinsic structure junctions. Considering the overall enhancement in conductivity, crystallinity, and microstructure order, it is the former. Therefore, the laser process, applied on a bulk textile scale, fundamentally enhances the intrinsic transport making a quasi-1D transport description more appropriate.

After laser treatment, the dominance of the extrinsic resistance is now the immediate obstacle to defeat before any further intrinsic enhancement will increase the conductivity. Nitric acid treatment enhances charge transfer across extrinsic interfaces, as well as doping semi-conducting CNT species. Samples were soaked with 70% nitric acid and allowed to dry under a heat lamp for approximately an hour until the resistance stabilized.

After nitric acid treatment and stabilization, the laser treated sample resistance decreased by a factor of three. Assuming generously that this fivefold resistance drop relates to a fivefold increase in specific conductivity, at the time of writing the best photonic processed SWCNT textile at 1000 m² kg⁻¹Ω⁻¹ would become 5000 m² kg⁻¹Ω⁻¹. This exploratory effort shows signs of specific conductivity better then gold (2200 m² kg⁻¹ Ω⁻¹) and approaching silver (5800 m² kg⁻¹Ω⁻¹) and copper (6300 m² kg⁻¹Ω⁻¹). The as-is material that did not have the laser treatment, although had the HCl/H₂O wash, had a meagre conductivity enhancement of only 25%.

Shown in FIG. 11b is the resistance versus temperature dependence of the as-is and laser treated material—after the final nitric acid bath processing. As shown, the temperature response of the raw material does not change appreciably after nitric acid treatment. The standard metallic term in equation (1) still fits better than equation (2) and room temperature intrinsic/extrinsic contributions are still nearly evenly split (46% intrinsic/54% extrinsic). The photonic processed material on the other hand now appears relatively temperature independent with the nitric acid treatment suppressing the semi-conducting like, extrinsic resistance contribution. Upon closer inspection however, both metallic and semi-conducting temperature dependent regions are still present, albeit diminished in scale. The quasi-1D metallic term of equation (2) still yields the best fit and the room temperature intrinsic/extrinsic contributions at 14% intrinsic/86% extrinsic (see Table 1 for fitting parameters). Thus, photonic processing enables further transport enhancement with chemical treatment beyond what is experienced by the raw material. A possible explanation is that the amorphous and oligomeric carbon coatings inherent to the raw sample prevent adequate surface chemistry modification of the bundle work functions. The photonic processed material is a significantly better ordered, purer system that potentially permits the effects of surface chemistry modification to become more obvious.

TABLE 1
The best fitting parameters for the
fluctuation induced tunnelling model.

| | | | | | |
|---|---|---|---|---|---|
| RFIT | T1 (K) | T2 (K) | B | A | TPhonon (K) |

After HCl/H₂O Wash

| | | | | | | |
|---|---|---|---|---|---|---|
| Raw | 0.48 | 3.93 | 3.57 | 0.002 | | |
| Air Photonic | 0.80 | 4.89 | 4.97 | | 1.32 | 604 |
| Process | | | | | | |

After nitric acid treatment

| | | | | | | |
|---|---|---|---|---|---|---|
| Raw | 0.52 | 6.31 | 6.97 | 0.0015 | | |
| Air Photonic | 0.85 | 2.09 | 5.88 | | 1.21 | 653 |
| Process | | | | | | |

### Further Discussion

The photonic process is in effect a sorting procedure. Not only are amorphous carbon and/or partly ordered non-tubular carbons removed, but unlike any other type of annealing or oxidation procedure most CNTs are removed as well—only the most crystalline, aligned, and conductive SWCNT/DWCNT fraction survives. Measurements indicate temperatures well beyond the SWCNT oxidation threshold, resulting in the flash oxidation of amorphous carbon, partly ordered non-tubular carbons, and CNTs which cannot sufficiently transport heat. The rapid application and removal of the spatially selective illumination zone permits certain CNT bundles, with sufficient thermal conductivity, to transport the absorbed heat and survive. This is a unique attribute of a rastering laser approach that could not be replicated in a typical furnace where oxidation temperatures are uniformly maintained for too long a duration. To be effective, the material at the treatment region should not be in thermal contact with a heat sink in the form of a substrate. This is in contrast with other air annealing laser techniques (Corio et al. (2002), Huang et al. (2006), Mahjouri-Samani et al. (2009), Souza et al. (2015)) where SWCNTs are supported by an underlying substrate and, over the course of tens of seconds or hours, a stationary laser gradually burns away a small SWCNT fraction. Note that not all CNT materials are improved by this process. High purity CNT textiles generated by floating catalyst chemical vapour deposition seem to benefit in particular.

Not found with other annealing procedures, photonic based or otherwise, the most distinctive benefit of the atmospheric photonic process is perhaps the profound improvement in CNT microstructure alignment. This may be the most critical parameter to address first for electrical transport. Exposure of the residual catalyst, enabling its removal with an acid wash, is another benefit. Another particularly noteworthy effect is the near removal of the Raman spectra's D peak. The order of magnitude improvement in conductivity, along with the enhanced opportunity for chemical treatment, illustrates the emerging potential of CNT textiles. Further, the combined techniques of atmospheric photonic processing and rapid acid wash are relatively straightforward and robust procedures to implement in an industrial setting.

The treated material reported here has a micro-structure alignment and graphitic crystallinity comparable to fibers produced by Rice University [Behabtu et al (2013), http://www.assemblymag.com/articles/93180-can-carbon-nanotubes-replace-copper] and their spin-off company DexMat, although uniquely have individual CNT length significantly greater than the Rice University fibers. A limitation of the Rice University fiber is that at the current stage of development, they cannot go beyond 20 μm in length [Behabtu et al (2013), and Behabtu et al (2008)]. The CNTs in fibers from floating catalyst chemical vapor deposition are up to 1 mm in length [Behabtu et al (2008), Motta et al (2008), Koziol et al (2007)]. Alignment, crystallinity, and length are considered to be the single most important factors to improving CNT conductivity and it is expected laser processed CNT fiber will beat the electrical and thermal conductivity of Rice fiber with further development because of their inherently longer length. At the time of writing, the preferred embodiments of the invention produce treated materials having electrical conductivity of 3 MSm⁻¹. On a weight basis this is 5 kSm² kg⁻¹.

For microstructural alignment, a useful figure of merit is the Herman orientation parameter for morphologies that are either isotropic, or anistropic with rotational symmetry about one axis such as for example fibers, or the Chebyshev's orientation parameter for for layered morphologies with no out-of-plane orientation such as for example layered films.

Traditionally this is accomplished by X-ray diffraction, although this can also be obtained by scanning electron microscopy or Raman spectroscopy. The Herman orientation parameter varies between −0.5 (perpendicular alignment), through zero (no/random alignment), to one (complete alignment). The preferred embodiments of the invention preferably have alignment corresponding to a Herman orientation parameter of at least 0.7. For reference, the Rice University process reports a Herman orientation parameter of 0.9 [Behabtu et al (2013)]. See FIG. 15 for an example of a X-ray diffraction pattern (azimuthal scan) that produces a Herman orientation parameter. Preferably, the embodiments of the present invention provide a treated material with a Herman orientation parameter of at least 0.5.

The calculation of the Herman orientation parameter is a well-established technique [Koziol et al (2007)] and is as follows. The Herman orientation parameter S_{d} is calculated in respect to some axis of interest and, in our case, this axis of interest is the fiber direction. X-ray diffraction measurements, as shown in FIG. 15, yield an intensity/versus azimuthal angle β. As shown there are peaks of intensity which indicate orientation. If the intensity does not change with azimuthal angle, then the material has no orientation. In FIG. 15, the peaks are translated to the 90 and 270 degree positions, where these angles correspond to alignment with the fiber. Consider the angle φ, which is the angle between the normal of the scattering plane and the microstructure alignment. In most cases, φ≈β although in general cos (β) cos(θ_{B})=cos(φ) where θ_{B} is the Bragg angle. Herman orientation parameter S_{d} is then:

$${S}_{d} = \frac{3 〈 {cos}^{2} φ 〉 - 1}{2} \qquad Equation ( 3 )$$

Where <cos(φ)> is

$$〈 {cos}^{2} φ 〉 == \frac{{\int }_{0}^{2 π} I ( φ ) {cos}^{2} ( φ ) sin ( φ ) d φ}{{\int }_{0}^{2 π} I ( φ ) sin ( φ ) d φ} \qquad Equation ( 4 )$$

However, it is to be taken into account that the Herman's orientation function is used for spherical convolution and <Cos²ϕ> defined as above only applies to isotropic or rotationally symmetric samples, such as for example crystals or fibres.

CNT films for example, if produced by continuously layering thin films of uncondensed CNT aerogel on top of each other, can be assumed to be layered oriented planes without any orientation in depth. Therefore, we use Chebyshev's polynomial first grade for circular convolution to quantify the orientation [Gspann et al (2016)]. Chebyshev orientation parameter T2 is defined as

$$\begin{matrix}{T}_{2} = 2 〈 {cos}^{2} φ 〉 - 1 \\ With & Equation ( 5 ) \\ 〈 {cos}^{2} φ 〉 = \frac{\int I ( φ ) \cdot {cos}^{2} φ d φ}{\int I ( φ ) d φ} & Equation ( 6 )\end{matrix}$$

The limiting cases of T2 are: −1 for alignment perpendicular to the processing direction, 0 for no/random orientation, and 1 for alignment parallel to the processing direction.

For graphitic crystallinity, a suitable figure of merit is the D:G ratio of Raman spectroscopy. The lower this number, the higher the graphitic crystallinity and less the contribution of amorphous and other disordered carbons. In situations where disordered/amorphous carbon is not present with the CNTs, the D:G ratio is an indicator of defects on the CNT molecular structure. In situations where both disordered carbons and defects along the tube are not present, the D:G ratio indicates the presence of CNT tube ends, which are ultimately defects, and the D:G ratio is related to CNT length.

Measurement of the D:G ratio is dependent on many parameters such as Raman laser polarization, wavelength, dwell time and intensity. When care is take so that the dwell time and intensity do not significantly heat the sample, an un-polarized Raman laser with an un-polarized return to the detector, typical D:G ratios for a treated material according to an embodiment of the invention are 0.01 for 523 nm excitation and 0.04 for 785 nm excitation.

It is preferred that the treated material has a D:G ratio of at most 0.025 for 523 nm excitation and at most 0.1 for 785 nm excitation.

It is possible to plot the D:G ratio against the fourth power of wavelength. It is found that this may be fitted to a straight line with good fit. Preferred embodiments of the invention produce a reduced R² of the fit, with the origin included, of better than 0.9. At the time of writing, this straight line dependence for pure CNT textiles has not been reported previously.

It is preferred that the treated material has a reduced R² better than 0.7 when the D:G ratio is plotted against the fourth power of wavelength, when fitted with a straight line with the origin included.

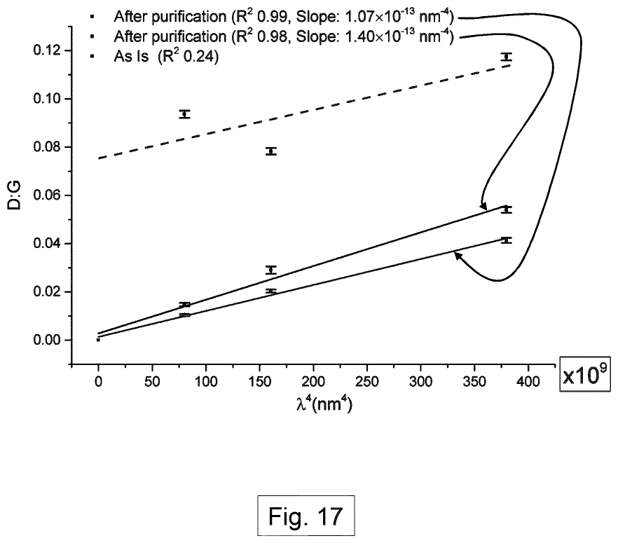

While this linear dependence is the expected behaviour of graphite and graphene [Ferrari and Basko (2013), Dresselhaus et al (2010)], on an individual basis, the unique chirality dependent effects of CNTs confounds the graphitic linear relationship, as has been shown in literature [Cou et al (2007)]. The present inventors have found that when the CNTs are in a bundled state such as a textile, the linear relationship is restored provided the CNTs are sufficiently pure. For CNT textiles manufactured as-is out of the chemical vapour deposition reactor, the purity is not sufficient and the linear relationship does not take hold. The products of the preferred embodiments of the invention however have sufficient purity and the linear relationship between the D:G ratio and excitation wavelength to the fourth power does apply (see FIG. 17). Note that this discussion of D:G ratio is assuming that the CNT sample is not under any significant influence of chemical species. Other chemicals such as acids may be used to further purify the CNT material as well as electronically dope them. The significant presence of a chemical species will distort the Raman signal and any interpretation of the DG ratio.

It is preferred that the average individual CNT length in the treated material is at least (and preferably greater than) 100 microns.

Because of their extreme aspect nature and heavily bundled, intertwined nature, measuring the individual CNT length in CNT textiles produced by floating catalyst chemical vapour deposition (CVD) can be a challenging process. The preferred measurement method is using transmission electron microscopy, as outlined in Motta et al (2008) and Koziol et al (2007). With this technique, the microscope scans over the material and counts the number of CNT tube walls and CNT tube ends. With this approach, it is found that the material has an average CNT length of about 1 mm. It is understood in this technical field that this measurement is not necessarily exact, because it is impossible to know that all of the CNT ends are accounted for. However, it is qualitatively clear that the CNTs are substantially longer than the approximately 20 micron CNT length from the Rice University process, and the approach is considered to provide reliable results on a quantitative basis at least in terms of the order of magnitude of the average CNT length.

There are other measurement techniques that have also been shown to find CNT length in CNT textiles with different degrees of effectiveness and applicable length scales. Part of the challenge is that many of these techniques may require ultra-sonication to de-bundle the network into isolated CNTs, and this has the unwanted side effect of also cutting and shortening the CNTs. Examples of measurement after an ultra-sonication step include using an atomic force microscope or transmission electron microscope on a sparse network of CNTs after a CNT suspension is dried on a substrate.

There are some measurement techniques that do not necessarily require ultra-sonication. These measurement techniques includes measuring CNTs in a solution (typically a super acid solution) where changes in viscosity are related to the CNT aspect ratio [Nicholas et al (2007), Tsentalovich et al (2016)]. It has also been demonstrated that CNTs in solution will experience a transition to a liquid crystalline phase at a concentration specified by the CNT length [Tsentalovich et al (2016)]. Another approach is infrared/THz/microwave spectroscopy where, for example, an absorbance peak in the spectrum corresponds to a Plasmon interaction dependent on the CNT length Akima et al (2006), Zhang et al (2013). In cases of high crystallinity and purity, as previously discussed, another technique is based on the D:G ratio of Raman spectroscopy where CNT length corresponds to the slope of the linear dependence between the D:G ratio against the forth power of Raman excitation wavelength [Cou et al (2007), Fagan et al (2007), Simpson et al (2008)].

Other ways to infer the long CNT length in textiles is measure various parameters as a function of length along the textile. For example, mechanical testing of stress versus strain for different gauge lengths along the textile can provide a measure of CNT length. Another example is to measure resistance versus temperature for different probe separation along a CNT fiber. In both of these examples, the relationship between dependent and independent variables will have limiting behaviour on scales either much smaller or much larger than the individual CNT length in the textile. Measuring the characteristic length where one limiting behaviour transitions to the other limiting behaviour may infer the CNT length.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

All references referred to above are hereby incorporated by reference.

### LIST OF NON-PATENT DOCUMENT REFERENCES

Ajayan, et al. (Apr. 26, 2002) Science, 296(5568): 705.
M. Yudasaka et al., “Diameter-selective removal of single-wall carbon nanotubes through light-assisted oxidation”, Chemical Physics Letters, vol. 374, pp. 132-136 (Jun. 4, 2003).
P. D. Kichambare et al., “Laser irradiation of carbon nanotubes”, Materials Chemistry and Physics, vol. 72, pp. 218-222 (2001).
N. Braidy et al., “Oxidation of Fe Nanoparticles Embedded in Single-Walled Carbon Nanotubes by Exposure to a Bright Flash of White Light”, Nano Letters, vol. 2, No. 11, pp. 1277-1280 (2002).
P. Corio, P. Santos, M. Pimenta and M. Dresselhaus, “Evolution of the molecular structure of metallic and semiconducting carbon nanotubes under laser irradiation,” Chem. Phys. Lett., vol. 360, p. 557-564, 2002.
H. Huang, R. Maruyama, K. Noda, H. Kajiura and K. Kadono, “Preferential destruction of metallic single-walled carbon nanotubes by laser irradiation,” J. Phys. Chem. B, vol. 110, pp. 7316-7320, 2006.
M. Mahjouri-Samani, Y. Zhou, W. Xiong, Y. Gao, M. Mitchell and Y. Lu, “Laser induced selective removal of metallic carbon nanotubes,” Nanotechnology, vol. 20, p. 495202, 2009.
N. Souza, M. Zeiger, V. Presser and F. Muecklich, “In situ tracking of defect healing and purification of single-wall carbon nanotubes with laser radiation by time-resolved Raman spectroscopy,” RSC Adv., vol. 5, pp. 62149-62159, 2015.
Z. Marković, D. Kepić, I. H. Antunović, M. Nikolić, M. Dramićanin, M. M. Cincovića and B. T. Markovića, “Raman study of single wall carbon nanotube thin films treated by laser irradiation and dynamic and isothermal oxidation,” J. Raman Spectrosc., vol. 43, p. 1413-1422, 2012.
K. Maehashi, Y. Ohno, K. Inoue and K. Matsumoto, “Chirality selection of single-walled carbon nanotubes by laser resonance chirality selection method,” Appl. Phys. Lett., vol. 85, pp. 848-860, 2004.
J. R. Mialichi, M. J. S. P. Brasil, F. Iikawa, C. Veríssimo and S. A. Moshkalev, “Laser irradiation of carbon nanotube films: Effects and heat dissipation probed by Raman spectroscopy,” J. Appl. Phys., vol. 114, p. 024904, 2013.
B. Wei, J. Zhang, J. Liang, W. Liu, Z. Gao and D. Wu, “Carbon nanotubes transfer to diamond by laser irradiation,” J. Mater. Sci. Lett., vol. 16, p. 402-403, 1997.
K. Ramadurai, C. L. Cromer, A. C. Dillon, R. L. Mahajan and J. H. Lehman, “Raman and electron microscopy analysis of carbon nanotubes exposed to high powerlaser irradiance,” J. Appl. Phys., vol. 105, p. 093106, 2009.
K. Liu, F. Zhu, L. Liu, Y. Sun, S. Fan and K. Jiang, “Fabrication and processing of high-strength densely packed carbon nanotube yarns without solution processes,” Nanoscale, vol. 4, pp. 3389-3393, 2012.
Behabtu et al., “Strong, Light, Multifunctional Fibers of Carbon Nanotubes with Ultrahigh Conductivity” Science 11 Jan. 2013: Vol. 339 no. 6116 pp. 182-186
H. Kajiura, A. Nandyala and A. Bezryadin, “Quasi-ballistic electron transport in as-produced and annealed multiwall carbon nanotubes,” Carbon, vol. 43, no. 6, p. 1317-1319, 2005.
L. Zhang, H. Li, K.-T. Yue, S.-L. Zhang, Xinghua, W. J. Zi, Z. Shi and Z. Gu, “Effects of intense laser irradiation on Raman intensity features of carbon nanotubes,” Phys. Rev. B, vol. 65, p. 073401, 2002.
K. E. Hurst, A. V. D. Geest, M. Lusk, E. Mansfield and J. H. Lehman, “Quartz-crystal microbalance for in situ monitoring of laser cleaning of carbon nanotubes,” Carbon, vol. 48, p. 2521-2525, 2010.
T. S. Gspann, F. R. Smail and A. H. Windle, “Spinning of carbon nanotube fibres using the floating catalyst high temperature route: Purity issues and the critical role of sulphur,” Faraday Discuss., vol. 173, pp. 47-65, 2014.
K. Koziol, J. Vilatela, A. Moisala, M. Motta, P. Cunniff, M. Sennett and A. Windle, “High-performance carbon nanotube fiber,” Science, vol. 318, pp. 1892-1895, 2007.
Behabtu et al, Science, p. 182, 2013.
http://www.assemblymag.com/articles/93180-can-carbon-nanotubes-replace-copper [Accessed 29 Nov. 2016].
Behabtu et al, Nano Today, vol. 3, p. 24, 2008.
M. S. Motta et al, J. Nanosci. Nanotechnol., vol. 8, p. 2442-2449, 2008.
C. Ferrari and D. M. Basko, “Raman spectroscopy as a versatile tool for studying the properties of graphene,” Nat. Nanotechnol., vol. 8, pp. 235-246, 2013.
M. S. Dresselhaus, A. Jorio, A. S. Filho and R. Saito, “Defect characterization in graphene and carbon nanotubes using Raman spectroscopy,” Phil. Trans. R. Soc. A, vol. 368, pp. 5355-5377, 2010.
S. G. Cou, H. S. J. Kong, A. J. R. Saito, M. Zheng, G. Dresselhaus and M. Dresselhaus, “Length characterization of DNA-wrapped carbon nanotubes using Raman Spectrocopy,” Appl. Phys. Lett., vol. 90, p. 131109, 2007.
Nicholas et al, “Simple Length Determination of Single-Walled Carbon Nanotubes by Viscosity Measurements in Dilute Suspensions,” Macromolecules, vol. 40, pp. 4043-4047, 2007.
D. E. Tsentalovich et al, “Relationship of Extensional Viscosity and Liquid Crystalline Transition to Length Distribution in Carbon Nanotube Solutions,” Macromolecules, vol. 49, p. 681-689, 2016.
N. Akima, Y. Iwasa, S. Brown, A. M. Barbour, J. Cao, J. L. Musfeldt, H. Matsui, N. Toyota, M. Shiraishi, H. Shimoda and O. Zhou, “Strong anisotropy in the far-infrared absorption spectra of stretch-aligned single-walled carbon nanotubes,” Adv. Mater., vol. 18, p. 1166-1169, 2006.
Q. Zhang, E. Haroz, Z. Jin and J. Kono, “Plasmonic nature of the terahertz conductivity peak in single-wall CNT,” Nano Lett., vol. 13, no. 12, pp. 5991-5996, 2013.
J. A. Fagan, J. R. Simpson, B. J. Bauer, S. H. D. P. Lacerda, M. L. Becker, J. Chun, K. B. Migler, A. R. H. Walker and E. K. Hobbie, “Length-dependent optical effects in single-wall carbon nanotubes,” J. Am. Chem. Soc., vol. 129, pp. 10607-10612, 2007.
J. R. Simpson, J. A. Fagan, M. L. Becker, E. K. Hobbie and A. R. H. Walker, “Length-dependent Raman spectroscopy of single-walled carbon nanotubes: the effect of dispersant on defects,” Condens. Mater., pp. 1-3, 2008.
T Gspann, S Juckes, J Niven, M Johnson, J. Elliot, M. White, A, Windle, High thermal conductivities of carbon nanotube films and micro-fibres and their dependence on morphology, Carbon, Vol 114 pp 160-168, 2017.
D. Tristant et al. Enlightening the ultrahigh electrical conductivities of doped double-wall carbon nanotube fibers by Raman spectroscopy and first-principles calculations. Nananoscale, vol 8, pp 19668-19676, 2016.

1. A method for treating carbon nanotube-based material including the steps:
providing a carbon nanotube-based material;
suspending the carbon nanotube-based material in an oxidative atmosphere;
illuminating an illumination portion of the carbon nanotube-based material with electromagnetic radiation to heat the illumination portion, the illumination portion being out of direct contact with any supporting surface, heat being continuously conducted away from the illumination portion to a non-illumination portion of the carbon nanotube-based material, said heating in the oxidative atmosphere causing at least partial oxidation and at least partial removal of amorphous carbon, partly ordered non-tubular carbon, and/or defective nanotubes in the carbon nanotube-based material, leaving a treated material comprising an arrangement of remaining carbon nanotubes.

2. The method according to claim 1 wherein the heating in the oxidative atmosphere causes at least partial oxidation and at least partial removal of nanotubes not part of a sufficient thermally conductive pathway to allow transport of heat away before oxidation of those nanotubes.

3. The method according to claim 1 wherein the carbon nanotube-based material has a footprint area of at least 0.1 cm².

4. The method according to claim 1 wherein the carbon nanotube-based material comprises at least 50 wt % carbon nanotubes.

5. The method according to claim 1 wherein the carbon nanotube-based material comprises at least 5 wt % carbon nanotubes selected from one or more of: single wall carbon nanotubes, double wall carbon nanotubes, and triple walled carbon nanotubes.

6. The method according to claim 1 wherein single, double and triple wall carbon nanotubes in the carbon nanotube-based have an average length of at least 100 μm.

7. The method according to claim 1 wherein the density of the carbon nanotube-based material is at least 0.05 gcm⁻³.

8. The method according to claim 1 wherein the carbon nanotube-based material is manufactured by chemical vapour deposition on floating catalyst particles.

9. The method according to claim 1 wherein the non-illumination portion of the carbon nanotube-based material has an area of at least 5 times the area of the illumination portion at a given instant in time during treatment.

10. The method according to claim 1 wherein the electromagnetic radiation is moved relative to the carbon nanotube-based material so as to move the illumination portion progressively along the carbon nanotube-based material.

11. The method according to claim 10 wherein the carbon nanotube-based material has a direction of preferential alignment of the carbon nanotubes, and the direction of relative movement of the illumination portion is substantially parallel to the direction of preferential alignment of the carbon nanotubes.

12. The method according to claim 1 wherein the illumination of the illumination portion by the electromagnetic radiation takes place over a time scale not longer than the duration of an oxidation chemical reaction corresponding to said least partial oxidation.

13. The method according to claim 1 wherein the electromagnetic radiation is pulsed in time so that the duration of each pulse of the electromagnetic radiation is not longer than the duration of an oxidation chemical reaction corresponding to said least partial oxidation.

14. The method according to claim 1 wherein, for a region of the material being illuminated, the electromagnetic radiation is pulsed in time so that the cumulative duration of the pulses of the electromagnetic radiation is not longer than the duration of an oxidation chemical reaction corresponding to said least partial oxidation.

15. The method according to claim 1 wherein the temperature of the illumination portion is at least 300° C.

16. The method according to claim 1 wherein the temperature of the illumination portion is at most 2500° C.

17. The method according to claim 1 wherein the fluence and/or intensity of the electromagnetic radiation at the illumination portion is sufficient to heat the carbon nanotube-based material to reach at least the lowest ignition temperature of all present carbon species at the illumination portion.

18. The method according to claim 1 wherein the ratio of the mass of the illumination portion after the process to the mass of the illumination portion before the process is at most 0.9 and at least 0.01.

19. The method according to claim 1 wherein the treated material is further treated to remove at least some residual catalyst particles and/or some amorphous carbon that remained after the primary treatment

20. The method according to claim 1 wherein, in the treated material, the carbon nanotubes are aligned to the extent that:
(i) where the treated material has a morphology such that micro-structure misalignment relative to the intended axis of micro-structure alignment is not constrained to one direction over another, the treated material has a Herman orientation parameter of at least 0.5; or
(ii) where the treated material has a morphology such that micro-structure misalignment relative to the intended axis of micro-structure alignment is predominantly constrained to one plane, the treated material has a Chebyshev's polynomial of at least 0.5.

21. The method according to claim 1 wherein, in the treated material, the carbon nanotubes have a graphitic crystallinity to the extent that when the material is subjected to non-polarized Raman spectroscopy to measure the ratio D:G of the magnitude of the D peak to the magnitude of the G peak, with magnitudes calculated by performing a baseline subtraction and integrating under the peaks of the non-polarized Raman spectrum, with Raman laser intensity sufficiently low to keep the calculated D:G ratio independent of Raman laser intensity within 10%, using light of wavelength 523 nm and 785 nm, the D:G ratio is at most 0.025 for 523 nm light and at most 0.1 for 785 nm light.

22. The method according to claim 1 wherein, in the treated material, the carbon nanotubes have a graphitic crystallinity to the extent that when the material is subjected to non-polarized Raman spectroscopy to measure the ratio D:G of the magnitude of the D peak to the magnitude of the G peak, with magnitudes calculated by performing a baseline subtraction and integrating under the peaks of the non-polarized Raman spectrum, with Raman laser intensity sufficiently low to keep the calculated D:G ratio independent of Raman laser intensity within 10%, using light of different wavelengths, when the D:G ratio is plotted against the fourth power of the Raman laser excitation wavelength and fitted to a straight line, with the straight line numerically constrained to the origin, the adjusted R² is at least 0.7.

23. A method for manufacturing and treating a carbon nanotube-based material including the steps:
forming an aerogel comprising at least carbon nanotubes, amorphous carbon, partly ordered non-tubular carbon, and catalyst particles by nucleation and growth of carbon nanotubes from a carbon material feedstock and floating catalyst particles in a reactor;
extracting and consolidating the aerogel into a carbon nanotube-based material;
suspending the carbon nanotube-based material in an oxidative atmosphere;
illuminating an illumination portion of the carbon nanotube-based material with electromagnetic radiation to heat the illumination portion, the illumination portion being out of direct contact with any supporting surface, heat being continuously conducted away from the illumination portion to a non-illumination portion of the carbon nanotube-based material, said heating in the oxidative atmosphere causing at least partial oxidation and at least partial removal of amorphous carbon, partly ordered non-tubular carbon, and/or defective nanotubes in the carbon nanotube-based material, leaving a treated material comprising an arrangement of remaining carbon nanotubes.

24. A carbon nanotube-based material comprising carbon nanotubes of average length at least 100 μm, the carbon nanotubes of the material being aligned to the extent that:
(i) where the treated material has a morphology such that micro-structure misalignment relative to the intended axis of micro-structure alignment is not constrained to one direction over another, the material has a Herman orientation parameter of at least 0.5; or
(ii) where the treated material has a morphology such that micro-structure misalignment relative to the intended axis of micro-structure alignment is predominantly constrained to one plane, the material has a Chebyshev's polynomial of at least 0.5,
and the carbon nanotubes of the material have graphitic crystallinity to the extent that when the material is subjected to non-polarized Raman spectroscopy to measure the ratio D:G of the magnitude of the D peak to the magnitude of the G peak, with magnitudes calculated by performing a baseline subtraction and integrating under the peaks of the non-polarized Raman spectrum, with Raman laser intensity sufficiently low to keep the calculated D:G ratio independent of Raman laser intensity within 10%, using light of wavelength 523 nm and 785 nm, the D:G ratio is at most 0.025 for 523 nm light and at most 0.1 for 785 nm light.

25. The carbon nanotube-based material according to claim 24 wherein:
(i) where the treated material has a morphology such that micro-structure misalignment relative to the intended axis of micro-structure alignment is not constrained to one direction over another, the material has a Herman orientation parameter of at least 0.6; or
(ii) where the treated material has a morphology such that micro-structure misalignment relative to the intended axis of micro-structure alignment is predominantly constrained to one plane, the material has a Chebyshev's polynomial of at least 0.6.

26. The carbon nanotube-based material according to claim 24 wherein:
(i) where the treated material has a morphology such that micro-structure misalignment relative to the intended axis of micro-structure alignment is not constrained to one direction over another, the material has a Herman orientation parameter of at least 0.7; or
(ii) where the treated material has a morphology such that micro-structure misalignment relative to the intended axis of micro-structure alignment is predominantly constrained to one plane, the material has a Chebyshev's polynomial of at least 0.7.

27. A carbon nanotube-based material comprising carbon nanotubes of average length at least 100 μm, the carbon nanotubes of the material being aligned to the extent that:
(i) where the treated material has a morphology such that micro-structure misalignment relative to the intended axis of micro-structure alignment is not constrained to one direction over another, the material has a Herman orientation parameter of at least 0.5; or
(ii) where the treated material has a morphology such that micro-structure misalignment relative to the intended axis of micro-structure alignment is predominantly constrained to one plane, the material has a Chebyshev's polynomial of at least 0.5,
and the carbon nanotubes of the material have graphitic crystallinity to the extent that when the material is subjected to non-polarized Raman spectroscopy to measure the ratio D:G of the magnitude of the D peak to the magnitude of the G peak, with magnitudes calculated by performing a baseline subtraction and integrating under the peaks of the non-polarized Raman spectrum, with Raman laser intensity sufficiently low to keep the calculated D:G ratio independent of Raman laser intensity within 10%, using light of different wavelengths, when the D:G ratio is plotted against the fourth power of the wavelength and fitted to a straight line, with the straight line numerically constrained to the origin, the adjusted R² is at least 0.7.

28. The carbon nanotube-based material according to claim 27, the carbon nanotubes of the material being aligned to the extent that:
(i) where the treated material has a morphology such that micro-structure misalignment relative to the intended axis of micro-structure alignment is not constrained to one direction over another, the material has a Herman orientation parameter of at least 0.6; or
(ii) where the treated material has a morphology such that micro-structure misalignment relative to the intended axis of micro-structure alignment is predominantly constrained to one plane, the material has a Chebyshev's polynomial of at least 0.6.

29. The carbon nanotube-based material according to claim 27 wherein:
(i) where the treated material has a morphology such that micro-structure misalignment relative to the intended axis of micro-structure alignment is not constrained to one direction over another, the material has a Herman orientation parameter of at least 0.7; or
(ii) where the treated material has a morphology such that micro-structure misalignment relative to the intended axis of micro-structure alignment is predominantly constrained to one plane, the material has a Chebyshev's polynomial of at least 0.7.

30. The carbon nanotube-based material according to claim 27 wherein, when the D:G ratio is plotted against the fourth power of the wavelength and fitted to a straight line, with the straight line numerically constrained to the origin, the reduced R² is at least 0.8.

31. The carbon nanotube-based material according to claim 24 wherein the material is in the form of a fibre, textile, sheet or film.

32. The carbon nanotube-based material according to claim 24 wherein the material is light-transmissive.

33. The carbon nanotube-based material according to claim 31 wherein the material is provided in a free-standing format, without the need for a substrate for support.
